(19) United States
(12) Patent Application Publication
(10) Pub. No.: US 2020/0369697 A1
(43) Pub. Date: Nov. 26, 2020

(54) MOLYBDENUM OXO ALKYLIDENE COMPOUNDS, METHODS OF MAKING THE SAME AND USE THEREOF IN METATHESIS REACTIONS

(71) Applicants: Massachusetts Institute of Technology, Cambridge, MA (US); Trustees of Boston College, Chestnut Hill, MA (US)

(72) Inventors: Richard Royce Schrock, Winchester, MA (US); Konstantin V. Bukhryakov, Belmont, MA (US); Amir H. Hoveyda, Lincoln, MA (US)

(21) Appl. No.: 16/966,369

(22) PCT Filed: Feb. 8, 2019
(86) PCT No.: PCT/US2019/017348

§ 371 Date: Jul. 30, 2020

Related U.S. Application Data
(60) Provisional application No. 62/628,804, filed on Feb. 9, 2018.

(51) Int. Cl. C07F 11/00; C07B 35/08

(52) U.S. Cl. CPC C07F 11/00; C07B 35/08

(57) ABSTRACT

The invention relates to molybdenum oxo alkylidene complexes of formula (I) wherein R¹, R², R³, R⁴, R⁵ and n are defined in the description, methods of making same and use thereof in metathesis reactions.

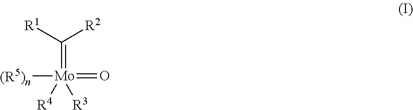

### CROSS-REFERENCE TO RELATED APPLICATIONS

This patent application claims priority to U.S. Provisional Patent Application No. 62/628,804, entitled “MOLYBDENUM OXO ALKYLIDENE COMPOUNDS, METHODS OF MAKING THE SAME AND USE THEREOF IN METATHESIS REACTIONS,” filed Feb. 9, 2018, which is incorporated herein by reference in its entirety.

### STATEMENT REGARDING FEDERALLY SPONSORED RESEARCH OR DEVELOPMENT

This invention was made with government support under Grant No. R01-GM059426 awarded by the National Institutes of Health, and Grant No. CHE-0946721 awarded by the National Science Foundation. The government has certain rights in the invention.

### FIELD OF THE INVENTION

The invention relates to molybdenum oxo alkylidene complexes, methods of making same and use thereof in metathesis reactions.

### BACKGROUND OF THE INVENTION

Imido alkylidene complexes of molybdenum and tungsten are frequently used as catalysts in metathesis reactions of olefins because an imido ligand was thought to be less likely than an oxo ligand to bridge between metals or to be attacked by an electrophile and removed, and thus to lose activity.

An approach to tungsten oxo alkylidenes allowed several examples that contain sterically demanding ligands to be prepared and their reactions explored (WO 2013/070725). Accordingly, a tungsten oxo alkylidene complex was the first high oxidation state complex to be prepared that would react with an olefin to give the new alkylidene expected from olefin metathesis. Contrary to this, isolable molybdenum oxo alkylidene complexes that are active for metathesis of olefins have remained elusive.

Two crystallographically characterized molybdenum oxo alkylidene thiolate complexes were prepared from Mo(IV) thiolate hydride complexes, phenylacetylene, and water, however, their olefin metathesis activities were not addressed (Fairhurst, S. A.; Hughes, D. L.; Marjani, K.; Richards, R. L. J. Chem. Soc., Dalton Trans. 1998, 1899-1904. Hughes, D. L.; Marjani, K.; Richards, R. L. J. Organomet. Chem. 1995, 505, 127-129).

Mo oxo alkylidene complex, Mo(O)(CHSiMe₃)[NP(t-Bu)₃]₂, was prepared via a five-coordinate bistrimethylsilylmethyl intermediate (Varjas, C. J.; Powell, D. R.; Thomson, R. K. Organometallics 2015, 34, 4806-4809). However, the steric and electronic properties of the [NP(t-Bu)₃]⁻ ligand prevent facile initiation of olefin metathesis reactions, even upon “activating” Mo(O)(CHSiMe₃)[NP(t-Bu)₃]₂ through addition of B(C₆F₅)₃ which is known to bind to the oxo ligand, a process that has been proposed to accelerate reactions of tungsten-based oxo alkylidene complexes with olefins by at least two orders of magnitude.

### OBJECTS OF THE INVENTION

Due to the growing importance of metathesis reactions not only at laboratory scale but in particular at industrial scale, there is an ongoing need for developing new catalysts and to test them for suitability in various types of metathesis reactions using various olefins to be metathesized. Thus, it was the object of the present invention to provide isolable molybdenum oxo alkylidene complexes that are active for metathesis of olefins.

### SUMMARY OF THE INVENTION

This object has been achieved with isolable molybdenum oxo alkylidene complexes that are active for metathesis of olefins, which are prepared through addition of water to a molybdenum alkylidyne complex. The molybdenum oxo alkylidene complexes may be provided in grafted form onto an oxidic solid support.

According to a first aspect, the invention relates to a molybdenum oxo alkylidene compound of formula I

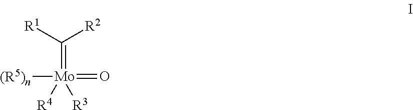

wherein:
one of R¹ and R² is H and the other is an optionally substituted group selected from: C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each of R³ and R⁴ is independently halogen, R, —N(R)₂, —NRC(O)R, —NRC(O)OR, —NRC(O)N(R)₂, —NRSO₂R, —NRSO₂N(R)₂, —NROR, —OR, or an optionally substituted group selected from a 5-6 membered monocyclic heteroaryl ring having at least one nitrogen and 0-3 additional heteroatoms independently selected from nitrogen, oxygen, or sulfur, a 4-7 membered saturated or partially unsaturated heterocyclic ring having at least one nitrogen and 0-2 additional heteroatoms independently selected from nitrogen, oxygen, or sulfur, a 7-10 membered bicyclic saturated or partially unsaturated heterocyclic ring having at least one nitrogen and 0-4 additional heteroatoms independently selected from nitrogen, oxygen, or sulfur, or an 8-10 membered bicyclic heteroaryl ring having at least one nitrogen and 0-4 additional heteroatoms independently selected from nitrogen, oxygen, or sulfur; or
two R groups on the same nitrogen atom are taken together with the nitrogen to form an optionally substituted 3-12 membered saturated, partially unsaturated, or aryl ring having 0-5 additional heteroatoms not including the same nitrogen atom independently selected from nitrogen, oxygen, or sulfur; or:
each R is independently hydrogen or an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2; or
one of R³ or R⁴ is a covalent bond linking Mo to an oxidic solid support.

According to a second aspect, the invention relates to a method of making a compound of formula I, the method comprising step (A):
(A) reacting an alkylidyne complex of formula II

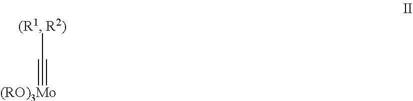

with water;
wherein R¹ or R² and R have the meaning as defined with respect to the compound of formula I.

According to a third aspect, the invention relates to a method of performing a metathesis reaction of an olefin using the compounds defined in the first aspect, the method comprising step (M):
(M) metathesizing an olefin in the presence of a compound as defined in the first aspect.

According to a fourth aspect, the invention relates to compounds useful as intermediates in the synthesis of the compounds according to the invention or prepared according to the method of the invention, wherein the compound is selected from:

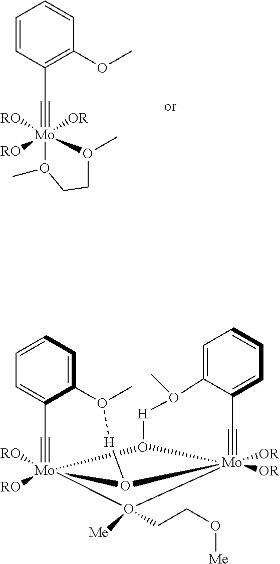

wherein RO is selected from (CF₃)(CH₃)₂CO—, (CF₃)₂(CH₃)CO— or (CF₃)₃CO—, preferably (CF₃)₂(CH₃)CO—.

According to a fifth aspect, the invention relates to a method of making a molybdenum oxo alkylidene complex of formula Ib

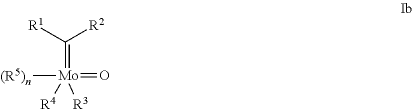

wherein:
one of R¹ and R² is H and the other is an optionally substituted group selected from:
O₁-₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each of R³ and R⁴ is independently halogen, R, —N(R)₂, —NRC(O)R, —NRC(O)OR, —NRC(O)N(R)₂, —NRSO₂R, —NRSO₂N(R)₂, —NROR, —OR, or an optionally substituted group selected from a 5-6 membered monocyclic heteroaryl ring having at least one nitrogen and 0-3 additional heteroatoms independently selected from nitrogen, oxygen, or sulfur, a 4-7 membered saturated or partially unsaturated heterocyclic ring having at least one nitrogen and 0-2 additional heteroatoms independently selected from nitrogen, oxygen, or sulfur, a 7-10 membered bicyclic saturated or partially unsaturated heterocyclic ring having at least one nitrogen and 0-4 additional heteroatoms independently selected from nitrogen, oxygen, or sulfur, or an 8-10 membered bicyclic heteroaryl ring having at least one nitrogen and 0-4 additional heteroatoms independently selected from nitrogen, oxygen, or sulfur; or
two R groups on the same nitrogen atom are taken together with the nitrogen to form an optionally substituted 3-12 membered saturated, partially unsaturated, or aryl ring having 0-5 additional heteroatoms not including the same nitrogen atom independently selected from nitrogen, oxygen, or sulfur; or:
each R is independently hydrogen or an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2; or
one of R³ or R⁴ is a covalent bond linking Mo to an oxidic solid support;
and wherein
one of R³ or R⁴ is a covalent bond linking Mo to an oxidic solid support;
the method comprising step (E):
(E) reacting a compound of formula Ia

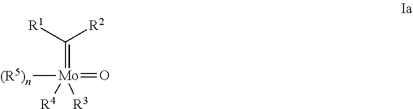

wherein:
one of R¹ and R² is H and the other is an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated carbocyclic ring; an 8-10 membered bicyclic saturated ring or aryl ring; a 5-6 membered monocyclic heteroaryl ring having 1-4 heteroatoms independently selected from nitrogen, oxygen, or sulfur; a 4-7 membered saturated heterocyclic ring having 1-3 heteroatoms independently selected from nitrogen, oxygen, or sulfur;
each of R³ and R⁴ is independently halogen, R, —N(R)₂, —NRC(O)R, —NRC(O)OR, —NRC(O)N(R)₂, —NRSO₂R, —NRSO₂N(R)₂, —NROR, —OR; or
two R groups on the same nitrogen atom are taken together with the nitrogen to form an optionally substituted 3-12 membered saturated ring or aryl ring having 0-5 additional heteroatoms not including the same nitrogen atom independently selected from nitrogen, oxygen, or sulfur; or:
each R is independently hydrogen or an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated carbocyclic ring; an 8-10 membered bicyclic saturated ring or aryl ring; a 5-6 membered monocyclic heteroaryl ring having 1-4 heteroatoms independently selected from nitrogen, oxygen, or sulfur; a 4-7 membered saturated heterocyclic ring having 1-3 heteroatoms independently selected from nitrogen, oxygen, or sulfur; a 7-10 membered bicyclic saturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2;
with an oxidic solid support.

The complexes known from the Background section, i.e. molybdenum oxo alkylidene thiolate complexes prepared from Mo(IV) thiolate hydride complexes, phenylacetylene, and water, as well as Mo oxo alkylidene complex, Mo(O)(CHSiMe₃)[NP(t-Bu)₃]₂, do not belong to the present invention.

### BRIEF DISCUSSION OF THE FIGURES

In the figures shows

FIG. 1 a drawing of compound 3(PPhMe₂);

FIG. 2 a drawing of compound 4(dme); and

FIG. 3 a drawing of compound 6.

### DETAILED DESCRIPTION OF THE INVENTION

According to a first aspect, the invention relates to a compound of formula I:

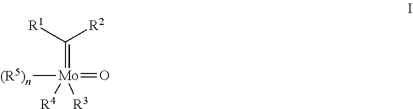

wherein:
one of R¹ and R² is H and the other is an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each of R³ and R⁴ is independently halogen; R; —N(R)₂, —NRC(O)R, —NRC(O)OR, —NRC(O)N(R)₂, —NRSO₂R, —NRSO₂N(R)₂, —NROR; —OR; or an optionally substituted group selected from a 5-6 membered monocyclic heteroaryl ring having at least one nitrogen and 0-3 additional heteroatoms independently selected from nitrogen, oxygen, or sulfur; a 4-7 membered saturated or partially unsaturated heterocyclic ring having at least one nitrogen and 0-2 additional heteroatoms independently selected from nitrogen, oxygen, or sulfur; a 7-10 membered bicyclic saturated or partially unsaturated heterocyclic ring having at least one nitrogen and 0-4 additional heteroatoms independently selected from nitrogen, oxygen, or sulfur; or an 8-10 membered bicyclic heteroaryl ring having at least one nitrogen and 0-4 additional heteroatoms independently selected from nitrogen, oxygen, or sulfur; or
two R groups on the same nitrogen atom are taken together with the nitrogen to form an optionally substituted 3-12 membered saturated, partially unsaturated, or aryl ring having 0-5 additional heteroatoms not including the same nitrogen atom independently selected from nitrogen, oxygen, or sulfur;
each R is independently hydrogen or an optionally substituted group selected from: C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2; or
one of R³ or R⁴ is a covalent bond linking Mo to an oxidic solid support.

In one embodiment, one of R¹ and R² is H and the other is an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated carbocyclic ring; an 8-10 membered bicyclic saturated ring or aryl ring; a 5-6 membered monocyclic heteroaryl ring having 1-4 heteroatoms independently selected from nitrogen, oxygen, or sulfur; a 4-7 membered saturated heterocyclic ring having 1-3 heteroatoms independently selected from nitrogen, oxygen, or sulfur; a 7-10 membered bicyclic saturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each of R³ and R⁴ is independently halogen; R; —N(R)₂, —NRC(O)R, —NRC(O)OR, —NRC(O)N(R)₂, —NRSO₂R, —NRSO₂N(R)₂, —NROR; —OR; or an optionally substituted group selected from a 5-6 membered monocyclic heteroaryl ring having at least one nitrogen and 0-3 additional heteroatoms independently selected from nitrogen, oxygen, or sulfur; a 4-7 membered saturated heterocyclic ring having at least one nitrogen and 0-2 additional heteroatoms independently selected from nitrogen, oxygen, or sulfur; a 7-10 membered bicyclic saturated heterocyclic ring having at least one nitrogen and 0-4 additional heteroatoms independently selected from nitrogen, oxygen, or sulfur; or an 8-10 membered bicyclic heteroaryl ring having at least one nitrogen and 0-4 additional heteroatoms independently selected from nitrogen, oxygen, or sulfur; or
two R groups on the same nitrogen atom are taken together with the nitrogen to form an optionally substituted 3-12 membered saturated ring or aryl ring having 0-5 additional heteroatoms not including the same nitrogen atom independently selected from nitrogen, oxygen, or sulfur;
each R is independently hydrogen or an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated carbocyclic ring; an 8-10 membered bicyclic saturated ring or aryl ring; a 5-6 membered monocyclic heteroaryl ring having 1-4 heteroatoms independently selected from nitrogen, oxygen, or sulfur; a 4-7 membered saturated ring having 1-3 heteroatoms independently selected from nitrogen, oxygen, or sulfur; a 7-10 membered bicyclic saturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2; or
one of R³ or R⁴ is a covalent bond linking Mo to an oxidic solid support.

In one embodiment, one of R¹ and R² is —C(CH₃)₃.

In another embodiment, one of R¹ and R² is —C(CH₃)₂C₆H₅.

In yet another embodiment, one of R¹ and R² is optionally substituted phenyl.

The term “optionally substituted” encompasses one or more substituents selected from R; —N(R)₂, —NRC(O)R, —NRC(O)OR, —NRC(O)N(R)₂, —NRSO₂R, —NRSO₂N(R)₂, —NROR; —OR, wherein R has the meaning as defined above.

In a preferred embodiment, one of R¹ and R² is optionally substituted phenyl bearing in ortho-position a O—R⁷ residue.

In another preferred embodiment, one of R¹ and R² is optionally substituted phenyl bearing in para-position a O—R⁷ residue.

In one embodiment, R⁷=C₁₋₈ alkyl, optionally substituted.

Preferred R⁷ residues are methyl, ethyl, n-propyl, isopropyl, n-butyl, iso-butyl, t-butyl and cyclohexyl.

In a preferred embodiment, O—R⁷ is O-(ortho-CH₃O—C₆H₄).

In another preferred embodiment, O—R⁷ is O-(para-CH₃O—C₆H₄)

Preferred optional substituents in R⁷=C₁₋₈ alkyl are one or more of halogen, cyano, C₁₋₈ alkyl, C₁₋₈ alkoxy or phenyl.

In one embodiment, substituted C₁₋₈ alkyl is preferably fluorine-substituted C₁₋₈ alkyl such as C(CH₃)(CF₃)₂ or perfluoro C₁₋₈ alkyl such as trifluoromethyl or C(CF₃)₃.

Other preferred optional substituents in R⁷=C₁₋₈ alkyl may be selected from carboxylic esters C(O)OR⁸, wherein R⁸=C₁₋₈ alkyl or phenyl.

Other preferred optional substituents in R⁷=C₁₋₈ alkyl are derivatives of hydroxamic acids C(O)NHOR⁸, wherein R⁸=C₁₋₈ alkyl or phenyl, or C(OR⁸)NOR⁸, wherein R⁸ independently from each other have the meaning of C₁₋₈ alkyl or phenyl.

Other preferred optional substituents in R⁷=C₁₋₈ alkyl are amides C(O)NHR⁸, wherein R⁸=C₁₋₈ alkyl or phenyl, and amides C(O)N(R⁸)₂, wherein R⁸ independently from each other have the meaning of C₁₋₈ alkyl or phenyl.

In another preferred embodiment, R⁷=CHR⁸COOR⁸, CHR⁸C(O)NHOR⁸, or CHR⁸C(OR⁸)NOR⁸, CHR⁸C(O)NHR⁸, or CHR⁸C(O)N(R⁸)₂, wherein R⁸ independently from each other have the meaning of C₁₋₈ alkyl or phenyl.

In another embodiment, R⁷=C₆₋₁₀ aryl such as phenyl, optionally substituted.

Preferred optional substituents in R⁷=C₆₋₁₀ aryl such as phenyl are one or more of halogen, cyano, C₁₋₈ alkyl, C₁₋₈ alkoxy or phenyl.

Substituted phenyl is e.g. C₆F₅.

In a further embodiment, each of R³ and R⁴ is independently halogen, —N(R)₂, or —OR, wherein R has the meaning as defined above.

In one embodiment, each of R³ and R⁴ is independently halogen.

The term “halogen” encompasses fluorine, chlorine, bromine and iodine.

In a preferred embodiment, each of R³ and R⁴ is chlorine.

In another embodiment, one of R³ and R⁴ is halogen and the other is —OR.

In still another embodiment, each of R³ and R⁴ is independently —OR.

In a preferred embodiment, —OR is —O-aryl, wherein aryl may be substituted.

A preferred aryl residue is phenyl. Said phenyl residue of —O-aryl may be substituted with one or more substituents selected from R; —N(R)₂, —NRC(O)R, —NRC(O)OR, —NRC(O)N(R)₂, —NRSO₂R, —NRSO₂N(R)₂, —NROR; —OR, wherein R has the meaning as defined above.

In another preferred embodiment, said phenyl residue is substituted in 2- and 6-position with another aryl residue, respectively, which may optionally be substituted.

Preferred substituted phenyl residues are selected from the group: 2,6-(diphenyl)phenyl, 2,6-di(2,4,6-trimethylphenyl)phenyl, 2,6-di(2,4,6-triethylphenyl)phenyl, 2,6-di(2,4,6-triisopropylphenyl)phenyl, 2,6-di(2,4,6-tri-t-butylphenyl)phenyl, 2,6-di(2,4,6-triphenyl)phenyl, 2,6-di(3,5-di-t-butylphenyl)phenyl, 2,6-di(pentafluorophenyl)phenyl, 2,3,5,6-tetra(phenyl)phenyl, 4-bromo-2,3,5,6-tetra(phenyl)phenyl, 4-nitro-2,3,5,6-tetra(phenyl)phenyl, 4-amino-2,3,5,6-tetra(phenyl)phenyl, and 4-cyano-2,3,5,6-tetra(phenyl)phenyl.

Further preferred substituted phenyl residues are selected from the group: 2,6-di(2,6-dimethylphenyl)phenyl, 2,6-di(2,6-diethylphenyl)phenyl, 2,6-di(2,6-diisopropylphenyl)phenyl, 2,6-di(2,6-di-t-butylphenyl)phenyl, and 2,6-di(2,6-diphenyl)phenyl.

In another preferred embodiment, said phenyl residue is substituted in 2- and 6-position with another aryl residue, respectively, which may optionally be substituted, and in 3- and 5-position with an alkyl residue. The alkyl residue preferably is a C₁₋₄ alkyl residue. In one embodiment, said alkyl residue is selected from methyl, ethyl, isopropyl, and t-butyl.

In one embodiment, substituted phenyl residues are selected from the group: 2,6-(diphenyl)-3,5-dimethyl-phenyl, 2,6-di(2,4,6-trimethylphenyl)-3,5-dimethyl-phenyl, 2,6-di(2,4,6-triethylphenyl)-3,5-methyl-phenyl, 2,6-di(2,4,6-triisopropylphenyl)-3,5-dimethylphenyl, 2,6-di(2,4,6-tri-t-butylphenyl)-3,5-dimethyl-phenyl, 2,6-di(2,4,6-triphenyl)-3,5-dimethyl-phenyl, 2,6-di(3,5-di-t-butylphenyl)-3,5-dimethyl-phenyl, and 2,6-di(pentafluorophenyl)-3,5-dimethyl-phenyl,

In another preferred embodiment, said phenyl residue is substituted in 2- and 6-position with another aryl residue, respectively, which may optionally be substituted, in 3- and 5-position with an alkyl residue, and in 4-position with a group selected from C₁₋₄ alkyl, halogen, cyano, amino, nitro. In one embodiment, said alkyl residue is selected from methyl, ethyl, isopropyl, and t-butyl.

Exemplary compounds are 4-bromo-2,6-(diphenyl)phenyl-3,5-dimethyl-phenyl, 4-nitro-2,6-(diphenyl)-3,5-dimethyl-phenyl, 4-amino-2,6-(diphenyl)-3,5-dimethyl-phenyl, and 4-cyano-2,6-(tetraphenyl)-3,5-dimethyl-phenyl.

In another preferred embodiment, —OR is selected from (CF₃)(CH₃)₂CO—, (CF₃)₂(CH₃)CO—, or (CF₃)₃CO.

In another embodiment, one of R³ and R⁴ is halogen and the other is —N(R)₂wherein R has the meaning as defined above.

In yet another embodiment each of R³ and R⁴ is independently —N(R)₂.

In a preferred embodiment, —N(R)₂ is selected from pyrrol-1-yl, 2,5-dimethylpyrrol-1-yl and 2,5-diphenylpyrrol-1-yl.

In another embodiment, one of R³ and R⁴ is —N(R)₂ and the other one is —OR, wherein R has the meaning as defined above.

According to the invention, R⁵ is a neutral ligand. Preferably, each R⁵ is independently a monodentate ligand, or two R⁵ are taken together with their intervening atoms to form an optionally substituted bidentate group.

In one embodiment, R⁵ is selected from an ether, a nitrile, a pyridine or a phosphine.

The ether may be an aliphatic ether such as diethyl ether (et₂O) or dimethyl ethylene glycol (dme) or a cyclic ether such as tetrahydrofuran (THF).

The nitrile may be an alkyl nitrile such as methane nitrile, ethane nitrile or propane nitrile or an aromatic nitrile such as benzonitrile.

The pyridine may be substituted or unsubstituted pyridine.

In a preferred embodiment, R⁵ is a phosphine.

In one embodiment, the phosphine is of formula P(R⁶)₃ wherein R⁶ is independently selected from C₁₋₆ alkyl, C₃₋₆ cycloalkyl, and phenyl.

Exemplary phosphines are trimethylphosphine (PMe₃), triethylphosphine, triisopropylphosphine, tricyclohexylphosphine, dimethylphenylphosphine [PPhMe₂] and diphenylmethylphosphine [PPh₂Me].

Further according to the invention, one of R³ or R⁴ may be a covalent bond linking Mo to an oxidic solid support.

The oxidic solid support may be selected from an oxide of silicon, aluminum, titanium, vanadium, molybdenum, tungsten or a mixture of two or more thereof.

In a preferred embodiment, the oxidic solid support comprises or consists of an oxide of silicon.

In one embodiment, one of R³ or R⁴ is O—Si(O—)₃, i.e. —O(Si≡).

In one embodiment, the compound of formula I is selected from:
(R⁵)ₙX₂Mo(O)(CR¹R²),
(R⁵)ₙX(OR)Mo(O)(CR¹R²),
(R⁵)ₙ(OR)₂Mo(O)(CR¹R²),
(R⁵)ₙX(N(R)₂)Mo(O)(CR¹R²),
(R⁵)ₙ(N(R)₂)₂Mo(O)(CR¹R²), and
(R⁵)ₙ(OR)(N(R)₂)Mo(O)(CR¹R²),
wherein X is halogen, and R¹, R², R⁵, R and n have the meaning as defined above.

In another embodiment, one of R³ or R⁴ in the compound of formula I is ArO and R⁵ is a phosphine such as trimethylphosphine, dimethylphenylphosphine or diphenylmethylphosphine or a nitrile such as acetonitrile or a pyridine such as pyridine as defined in the following Table 1:

TABLE 1
Preferred ligands R^{3,} R⁴ and R⁵

| ArO— | R⁵ |
|---|---|
| 2,6-di(phenyl)phenoxy | trimethylphosphine |
| 2,6-di(phenyl)phenoxy | dimethylphenylphosphine |
| 2,6-di(phenyl)phenoxy | acetonitrile |
| 2,6-di(phenyl)phenoxy | pyridine |
| 2,6-di(2,4,6-trimethylphenyl)phenoxy | trimethylphosphine |
| 2,6-di(2,4,6-trimethylphenyl)phenoxy | dimethylphenylphosphine |
| 2,6-di(2,4,6-trimethylphenyl)phenoxy | acetonitrile |
| 2,6-di(2,4,6-trimethylphenyl)phenoxy | pyridine |
| 2,6-di(2,4,6-triethylphenyl)phenoxy | trimethylphosphine |
| 2,6-di(2,4,6-triethylphenyl)phenoxy | dimethylphenylphosphine |
| 2,6-di(2,4,6-triethylphenyl)phenoxy | acetonitrile |
| 2,6-di(2,4,6-triethylphenyl)phenoxy | pyridine |
| 2,6-di(2,4,6-triisopropylphenyl)phenoxy | trimethylphosphine |
| 2,6-di(2,4,6-triisopropylphenyl)phenoxy | dimethylphenylphosphine |
| 2,6-di(2,4,6-triisopropylphenyl)phenoxy | acetonitrile |
| 2,6-di(2,4,6-triisopropylphenyl)phenoxy | pyridine |
| 2,6-di(2,4,6-tri-t-butylphenyl)phenoxy | trimethylphosphine |
| 2,6-di(2,4,6-tri-t-butylphenyl)phenoxy | dimethylphenylphosphine |
| 2,6-di(2,4,6-tri-t-butylphenyl)phenoxy | acetonitrile |
| 2,6-di(2,4,6-tri-t-butylphenyl)phenoxy | pyridine |
| 2,6-di(3,5-di-t-butylphenyl)phenoxy | trimethylphosphine |
| 2,6-di(3,5-di-t-butylphenyl)phenoxy | dimethylphenylphosphine |
| 2,6-di(3,5-di-t-butylphenyl)phenoxy | acetonitrile |
| 2,6-di(3,5-di-t-butylphenyl)phenoxy | pyridine |
| 2,6-di(pentafluorophenyl)phenoxy | trimethylphosphine |
| 2,6-di(pentafluorophenyl)phenoxy | dimethylphenylphosphine |
| 2,6-di(pentafluorophenyl)phenoxy | acetonitrile |
| 2,6-di(pentafluorophenyl)phenoxy | pyridine |
| 2,3,5,6-tetra(phenyl)phenoxy | trimethylphosphine |
| 2,3,5,6-tetra(phenyl)phenoxy | dimethylphenylphosphine |
| 2,3,5,6-tetra(phenyl)phenoxy | acetonitrile |
| 2,3,5,6-tetra(phenyl)phenoxy | pyridine |
| 4-bromo-2,3,5,6-tetra(phenyl)phenoxy | trimethylphosphine |
| 4-bromo-2,3,5,6-tetra(phenyl)phenoxy | dimethylphenylphosphine |
| 4-bromo-2,3,5,6-tetra(phenyl)phenoxy | acetonitrile |
| 4-bromo-2,3,5,6-tetra(phenyl)phenoxy | pyridine |
| 4-nitro-2,3,5,6-tetra(phenyl)phenoxy | trimethylphosphine |
| 4-nitro-2,3,5,6-tetra(phenyl)phenoxy | dimethylphenylphosphine |
| 4-nitro-2,3,5,6-tetra(phenyl)phenoxy | acetonitrile |
| 4-nitro-2,3,5,6-tetra(phenyl)phenoxy | pyridine |
| 4-amino-2,3,5,6-tetra(phenyl)phenoxy | trimethylphosphine |
| 4-amino-2,3,5,6-tetra(phenyl)phenoxy | dimethylphenylphosphine |
| 4-amino-2,3,5,6-tetra(phenyl)phenoxy | acetonitrile |
| 4-amino-2,3,5,6-tetra(phenyl)phenoxy | pyridine |
| 4-cyano-2,3,5,6-tetra(phenyl)phenoxy | trimethylphosphine |
| 4-cyano-2,3,5,6-tetra(phenyl)phenoxy | dimethylphenylphosphine |
| 4-cyano-2,3,5,6-tetra(phenyl)phenoxy | acetonitrile |
| 4-cyano-2,3,5,6-tetra(phenyl)phenoxy | pyridine |
| 2,6-di(2,6-dimethylphenyl)phenoxy | trimethylphosphine |
| 2,6-di(2,6-dimethylphenyl)phenoxy | dimethylphenylphosphine |
| 2,6-di(2,6-dimethylphenyl)phenoxy | acetonitrile |
| 2,6-di(2,6-dimethylphenyl)phenoxy | pyridine |
| 2,6-di(2,6-diethylphenyl)phenoxy | trimethylphosphine |
| 2,6-di(2,6-diethylphenyl)phenoxy | dimethylphenylphosphine |
| 2,6-di(2,6-diethylphenyl)phenoxy | acetonitrile |
| 2,6-di(2,6-diethylphenyl)phenoxy | pyridine |
| 2,6-di(2,6-diisopropylphenyl)phenoxy | trimethylphosphine |
| 2,6-di(2,6-diisopropylphenyl)phenoxy | dimethylphenylphosphine |
| 2,6-di(2,6-diisopropylphenyl)phenoxy | acetonitrile |
| 2,6-di(2,6-diisopropylphenyl)phenoxy | pyridine |
| 2,6-di(2,6-di-t-butylphenyl)phenoxy | trimethylphosphine |
| 2,6-di(2,6-di-t-butylphenyl)phenoxy | dimethylphenylphosphine |
| 2,6-di(2,6-di-t-butylphenyl)phenoxy | acetonitrile |
| 2,6-di(2,6-di-t-butylphenyl)phenoxy | pyridine |
| 2,6-di(2,6-diphenyl)phenoxy | trimethylphosphine |
| 2,6-di(2,6-diphenyl)phenoxy | dimethylphenylphosphine |
| 2,6-di(2,6-diphenyl)phenoxy | acetonitrile |
| 2,6-di(2,6-diphenyl)phenoxy | pyridine |

In one embodiment, one of R³ and R⁴ in the compound of formula I is ArO and R⁵ is a phosphine such as trimethylphosphine, dimethylphenylphosphine or diphenylmethylphosphine or a nitrile such as acetonitrile or a pyridine such as pyridine as defined in Table 1, n is 1, and one of R³ and R⁴ is chlorine.

In another embodiment, one of R³ and R⁴ in the compound of formula I is ArO and R⁵ is a phosphine such as trimethylphosphine or dimethylphenylphosphine or a nitrile such as acetonitrile or a pyridine such as pyridine as defined in the Table 1, and one of R³ and R⁴ is —N(R)₂selected from pyrrol-1-yl, 2,5-dimethylpyrrol-1-yl and 2,5-diphenylpyrrol-1-yl.

In another embodiment, the one of the respective residues R¹ and R² of the compounds defined in Table 1 is H and the other one is selected from C(CH₃)₃, —C(CH₃)₂C₆H₅, and preferably from optionally substituted phenyl, preferably bearing in o-position a —O—C₁₋₆ alkyl residue or in p-position a —O—C₁₋₆ alkyl residue.

In one embodiment, the compound of formula I is of structure

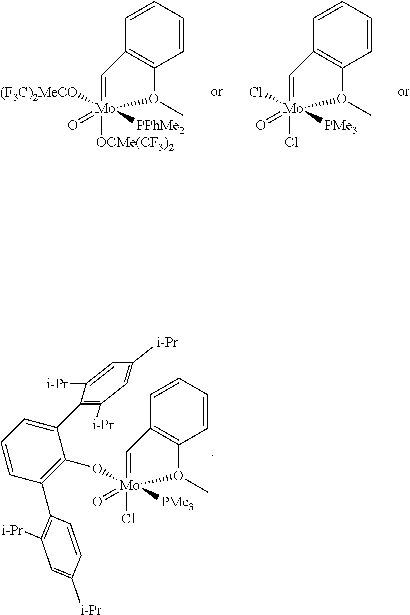

According to a second aspect, the invention relates to a method of making a compound of formula I as defined in the first aspect. The compound of formula I is prepared through addition of water to a molybdenum alkylidyne complex (molybdenum carbyne complex).

Accordingly, the method of making a compound of formula I comprises step (A):
(A) reacting an alkylidyne complex of formula II

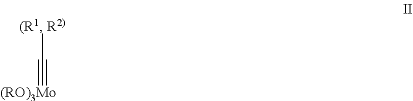

with water;
wherein R¹ or R² and R have the meaning as defined in the first aspect with respect to the compound of formula I. (R¹, R²) in formula II has the meaning of R¹ or R², i.e. the compound of formula II bears either a residue R¹ or R².

Molybdenum alkylidyne complexes (molybdenum carbyne complexes) are known or may be prepared according to known methods (e.g. von Kugelgen, S; Bellone, D. E.; Cloke, R. R.; Perkins, W. S.; Fischer, F. R.; J. Am. Chem. Soc. 2016, 138, 6234-6239).

In a preferred embodiment, the carbyne complex of formula II is stabilized by a neutral ligand. Preferred neutral ligands are preferably ethers defined in connection with neutral ligand R⁵. A particularly preferred ether is dimethyl ethylene glycol (dme), wherein dme is a bidentate ligand.

Accordingly, in one embodiment, the compound of formula II encompasses compounds such as II(dme), II(et₂O)_{1 or 2} and II(THF)_{1 or 2}.

However, suitable neutral ligands may also be nitriles or phosphines as defined with respect to the compounds of formula I.

Further preferably, —OR is selected from (CF₃)(CH₃)₂CO—, (CF₃)₂(CH₃)CO—, (CF₃)₃CO—, preferably (CF₃)₂(CH₃)CO—.

It is further preferred that in the compound of formula II none of R¹ or R² is hydrogen.

In one embodiment of the method according to the invention, if the compound of formula II is reacted with preferably one equivalent water in the presence of preferably one equivalent of ligand R⁵, water is added to the Mo-carbyne moiety, and a compound according to the invention of formula I is formed, wherein R³ and R⁴ are OR, respectively, and upon forming one equivalent ROH.

Accordingly, in one embodiment, the method of making a compound of formula I comprises step (A1):
(A1) reacting an alkylidyne complex of formula II [such as II(dme), II(et₂O)_{1 or 2} and II(THF)_{1 or 2}]

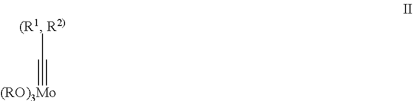

in the presence of neutral ligand R⁵ with water to afford a compound of formula I (R⁵)ₙ(OR)₂Mo(O)(CR¹R²), wherein n, R¹, R², R and R⁵ have the meaning as defined in the first aspect.

If the formed compound is reacted with a hydrogen halogenide HX, a further compound according to the invention of formula I (R⁵)ₙX₂Mo(O)(CR¹R²) is formed, wherein R³ and R⁴ are halogen X, respectively.

The compound formed in the reaction with hydrogen halogenide may subsequently be reacted according to following steps (B) or (C) with one equivalent or two equivalents of the respective anions RO⁻ or N(R)₂⁻, or with one equivalent of RO⁻ and then with another equivalent N(R)₂⁻ or vice versa according to following step (D) to afford further compounds according to the invention:
(B) reaction with RO⁻ to afford a compound according to the invention of formula I, wherein one of R³ and R⁴ is RO, wherein R has the meaning as defined with respect to formula I above, and the other one is halogen X, i.e. a compound of formula (R⁵)ₙX(OR)Mo(O)(CR¹R²); or
   to afford a compound according to the invention of formula I, wherein both R³ and R⁴ are RO, wherein R has the meaning as defined with respect to formula I above, i.e. a compound of formula (R⁵)ₙ(OR)₂Mo(O)(CR¹R²).
(C) reaction with N(R)₂⁻ to afford a compound of the invention of formula I wherein one of R³ and R⁴ is N(R)₂, wherein R has the meaning as defined with respect to formula I above, and the other one is halogen X, i.e. a compound of formula (R⁵)ₙX(N(R)₂)Mo(O)(CR¹R²); or
   to afford a compound according to the invention of formula I, wherein both R³ and R⁴ are N(R)₂, wherein R has the meaning as defined with respect to formula I above, i.e. a compound of formula (R⁵)ₙ(N(R)₂)₂Mo(O)(CR¹R²).
(D) reaction with RO⁻ and then with N(R)₂⁻ or vice versa to afford a compound of the invention of formula I, wherein one of R³ and R⁴ is OR and the other is N(R)₂, wherein R has the meaning as defined with respect to formula I above, i.e. a compound of formula (R⁵)ₙ(OR)(N(R)₂)Mo(O)(CR¹R²).

In an alternative embodiment, if the compound of formula II is at first reacted with water in the absence of a ligand R⁵ but in the presence of an ether as solvent, the reaction may proceed differently compared to step (A1).

The inventors discovered that under these reaction conditions in the reaction with water in an ether as solvent at first a dimeric alkylidyne complex [(RO)₂(Mo≡—(R₁,R₂)(—O—)₂(RO)₂(Mo≡—(R₁,R₂)]ether (ether=dme, et₂O or THF) may be formed and may be isolated or spectroscopically identified in the reaction mixture as intermediate.

This dimeric alkylidyne complex may be subsequently subjected to a reaction with neutral ligand R⁵. The resulting product corresponds to the product obtained in the embodiment in which an alkylidyne complex is subjected to a reaction with water in the presence of a neutral ligand R⁵.

Accordingly, in one embodiment, the method of making a compound of formula I comprises step (A2):
(A2) reacting an alkylidyne complex of formula II [such as II(dme), II(et₂O)_{1 or 2} and II(THF)_{1 or 2}] in the absence of R⁵ with water in presence of an ether as solvent, and subsequently reacting the formed reaction product [(RO)₂(Mo≡—(R₁,R₂)(—O—)₂(RO)₂(Mo≡—(R₁,R₂)]ether (ether=dme, et₂O or THF) with R⁵ to afford a compound of formula I.

The inventors have further discovered that known compounds of formula II may be easily converted to other carbyne complexes via a reaction with a suitable alkyne, i.e. by exchange of the carbyne moiety.

Accordingly, in one embodiment, the method further comprises prior to step (A) step (O):
(O) reacting a compound of formula II with a compound of formula III to afford a compound of formula IIa:

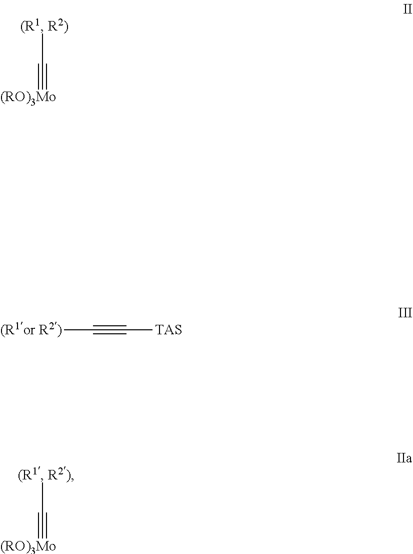

wherein TAS has the meaning of a trialkylsilane. R^{1′} or R^{2′} have the meaning as defined for R¹ or R² but are not identical to R¹ and R².

The compound of formula II is preferably provided in the form of an adduct with an ether, wherein the obtained compound of formula IIa is also in the form of an adduct with the ether, preferably dme.

Starting from easily available carbyne complexes, the reaction according to step (O) provides for an easy access to other carbyne complexes. These other carbyne complexes may then be processed according to step (A), e.g. steps (A1) or (A2), and subsequently according to step (B) or (C) or (D) in order to afford a compound of formula I.

In a preferred embodiment, —OR in the compound of formula IIa is selected from (CF₃)(CH₃)₂CO—, (CF₃)₂(CH₃)CO—, (CF₃)₃CO—, preferably (CF₃)₂(CH₃)CO—, and the ether is dme.

In a further preferred embodiment, —OR in the compound of formula IIa is selected from (CF₃)(CH₃)₂CO—, (CF₃)₂(CH₃)CO—, (CF₃)₃CO—, preferably (CF₃)₂(CH₃)CO—, the ether is dme and R^{1′}, R^{2′} is optionally substituted phenyl bearing in o-position a —O—C₁₋₆ alkyl residue.

According to a fifth aspect, if the compound of formula I should be bound (grafted) to an oxidic solid support, i.e. one of R³ or R⁴ is a covalent bond linking Mo to an oxidic solid support, a method is provided comprising step (E):
(E) reacting a compound of formula I with an oxidic solid support.

This means that said reacting is performed under the proviso that none of R³ or R⁴ of the compound of formula I used in step (E) is a covalent bond linking Mo to an oxidic solid support.

This reaction is identical with a method of making a grafted molybdenum oxo alkylidene complex of formula Ib

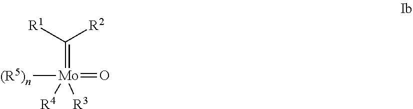

wherein:
one of R¹ and R² is H and the other is an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each of R³ and R⁴ is independently halogen, R, —N(R)₂, —NRC(O)R, —NRC(O)OR, —NRC(O)N(R)₂, —NRSO₂R, —NRSO₂N(R)₂, —NROR, —OR, or an optionally substituted group selected from a 5-6 membered monocyclic heteroaryl ring having at least one nitrogen and 0-3 additional heteroatoms independently selected from nitrogen, oxygen, or sulfur, a 4-7 membered saturated or partially unsaturated heterocyclic ring having at least one nitrogen and 0-2 additional heteroatoms independently selected from nitrogen, oxygen, or sulfur, a 7-10 membered bicyclic saturated or partially unsaturated heterocyclic ring having at least one nitrogen and 0-4 additional heteroatoms independently selected from nitrogen, oxygen, or sulfur, or an 8-10 membered bicyclic heteroaryl ring having at least one nitrogen and 0-4 additional heteroatoms independently selected from nitrogen, oxygen, or sulfur; or
two R groups on the same nitrogen atom are taken together with the nitrogen to form an optionally substituted 3-12 membered saturated, partially unsaturated, or aryl ring having 0-5 additional heteroatoms not including the same nitrogen atom independently selected from nitrogen, oxygen, or sulfur; or:
each R is independently hydrogen or an optionally substituted group selected from: C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2; or
one of R³ or R⁴ is a covalent bond linking Mo to an oxidic solid support;
and wherein
one of R³ or R⁴ is a covalent bond linking Mo to an oxidic solid support;
the method comprising step (E):

(E) reacting a compound of formula Ia

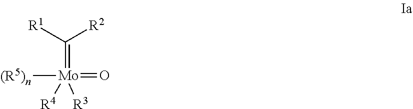

wherein:
one of R¹ and R² is H and the other is an optionally substituted group selected from:
C₁-₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each of R³ and R⁴ is independently halogen, R, —N(R)₂, —NRC(O)R, —NRC(O)OR, —NRC(O)N(R)₂, —NRSO₂R, —NRSO₂N(R)₂, —NROR, —OR, or an optionally substituted group selected from a 5-6 membered monocyclic heteroaryl ring having at least one nitrogen and 0-3 additional heteroatoms independently selected from nitrogen, oxygen, or sulfur, a 4-7 membered saturated or partially unsaturated heterocyclic ring having at least one nitrogen and 0-2 additional heteroatoms independently selected from nitrogen, oxygen, or sulfur, a 7-10 membered bicyclic saturated or partially unsaturated heterocyclic ring having at least one nitrogen and 0-4 additional heteroatoms independently selected from nitrogen, oxygen, or sulfur, or an 8-10 membered bicyclic heteroaryl ring having at least one nitrogen and 0-4 additional heteroatoms independently selected from nitrogen, oxygen, or sulfur; or
two R groups on the same nitrogen atom are taken together with the nitrogen to form an optionally substituted 3-12 membered saturated, partially unsaturated, or aryl ring having 0-5 additional heteroatoms not including the same nitrogen atom independently selected from nitrogen, oxygen, or sulfur; or:
each R is independently hydrogen or an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2;
with an oxidic solid support.

Suitable reaction conditions are known in the art, e.g. from WO 2015/049047.

The catalyst according to this aspect is heterogeneous.

The term “solid support” encompasses any material that includes an oxide of silica, alumina, and zirconia or oxides such as TiO₂, V₂O₅, MoO₂, WO₃, silicates, zeolites, or sulfates or phosphates of alkali metals or earth alkali metals

In a particularly preferred embodiment, said solid support comprises “silica” or consists of “silica”.

If silica is chosen as the solid support, the term “solid support” encompasses any material that includes silica such as silica as such or silica in combination with other materials. Accordingly, silica may be used in the form of a mixed oxide, e.g. a mixed oxide of silica and alumina or silica and zirconia or oxides such as TiO₂, V₂O₅, MoO₂, WO₃, silicates, zeolites, or sulfates or phosphates of alkali metals or earth alkali metals.

The term “silica” encompasses compounds of formula SiO₂ and further encompasses porous or non-porous silica.

The term “silica” further encompasses partially dehydroxylated and/or dehydrated silica. Dehydroxylation and/or dehydration may be performed using elevated temperature or elevated temperature and vacuum. Residual hydroxyl content may be determined by titration with MeMgCl.

Hydroxyl content may be freely selected depending on drying temperature and drying time. Accordingly, the silica used for the compounds according to the invention may be adjusted in a tailor-made manner to the required properties of the Mo-compound to be immobilized. In this regard it is noteworthy that depending on the number of mmol of hydroxyl groups per gram silica, the amount of Mo compound per gram of silica and ultimately the activity of the resulting catalyst may be adjusted depending upon needs.

Preferably, prior to step (E), silica is heated in a temperature range of from 150 to 1,000° C., preferably employing vacuum or a flow of dry air or inert gas such as nitrogen or argon.

In a further preferred embodiment, silica is subjected to a temperature in the range of from 300 to 800° C. under pressure ranging from 10⁻⁶ mbar to 1 bar or a flow of dry air or inert gas such as nitrogen or argon, preferably for a period ranging from 4 to 24 h. Temperature and pressure may be performed in ramps.

Preferably, hydroxyl content determined by means of titration with MeMgCI ranges from 0.05 mmol to 2.00 mmol per g silica, further preferred from 0.1 mmol to 2 mmol per g silica.

In one embodiment, silica is partially dehydroxylated and dehydrated at 700° C. (SiO₂₋₍₇₀₀₎). However, other temperatures or temperature ranges may also be used depending on the requirements of the catalyst to be prepared and to be used as heterogeneous catalyst.

Thus, preferably, a silica is used in one embodiment of the method according to the invention which is partially dehydroxylated and dehydrated. Preferably, silica is dehydroxylated and dehydrated at elevated temperature, preferably at elevated temperature and in vacuo or a flow of dry air or inert gas such as nitrogen or argon.

If silica or silca comprised in a solid support is heated at relatively low temperatures, it is conceivable that the method according to the invention predominatly or exclusively may result in a structure of formula (≡SiO)₂Mo(═O)(═CR¹R²).

The term “relatively low temperatures” relates to a temperature range of from 150 to 300° C., preferably 180 to 250° C., more preferably 200° C. If silica or silica comprised in an oxidic solid support is heated at relatively high temperatures, the method according to the invention predominatly or exclusively results in structures of formula (≡SiO)Mo(═O)(═CR¹R²)(R³ or R⁴). However it is conceivable that as by-product a compound of structure (≡SiO)Mo(═O)(—CHR¹R²)(R³)(R⁴) may be formed.

The term “relative high temperatures” relates to a temperature range of 400 to 1,000° C., preferably 600 to 800° C., more preferably 700° C.

Thus, when selecting a medium temperature range, it is conceivable to generate a mixture of structures comprising or consisting both of (≡SiO)₂Mo(═O)(═CR¹R²) and (≡SiO)Mo(═O)(═CR¹R²)(R³ or R⁴), and optionally (≡SiO)Mo(═O)(—CHR¹R²)(R³)(R⁴).

The term “medium temperatures” preferably relates to a temperature range of from 200 to 600° C., more preferably 300 to 500° C.

In one embodiment, the method comprises at least step (0.1) or (0.2) or (0.3) prior to step (E):
(0.1) heating silica or heating silica in vacuo; or
(0.2) heating silica or heating silica in vacuo or heating silica in a flow of dry air or inert gas in a temperature range of from 150° C. to 300° C.; or
0.3) heating silica or heating silica in vacuo or heating silica in a flow of dry air or inert gas in a temperature range of from 600° C. to 800° C.

Alternatively, the method comprises at least step (0.4):
(0.4) calcining silica at 500° C., rehydrating the calcined product at 200° C., and dehydroxylating the rehydrated product at 200° C. or higher.

In one embodiment, the grafted compound according to the invention may be prepared by contacting a solution or suspension of the molybdenum oxo alkylidene complex with a suspension of silica, preferably SiO₂₋₍₇₀₀₎, and stirring same at room temperature, e.g. for a period of from 2 to 24 h, preferably 6 to 18 h, whereby reaction (grafting) occurs.

Aromatics such as toluene or benzene, chlorinated hydrocarbons such as dichloromethane or chlorobenzene, or hydrocarbons such as heptane or octane or ethers such as tetrahydrofuran may be used as solvents. The proceeding of the reaction (grafting) may be frequently observed by fading of the color of the solution or suspension and a coloration of silica. The catalyst may be separated off, e.g. by filtration, and may be dried, preferably applying temperature and vacuum.

Accordingly, step (E) may be further characterized in that the reaction is carried out in an organic solvent.

Moreover, the method according to the invention according to step (E) may be further characterized in that the temperature employed in step (E) is from −80 to 150° C., preferably 0 to 80° C.

In another embodiment, the catalysts according to the invention are prepared by mixing the solid Mo oxo alkylidene complex of formula I with solid silica. In one embodiment of this method, ═CR¹R²is selected from ═CHC(CH₃)₃ or ═CHC(CH₃)₂C₆H₅.

In a preferred embodiment of this method, ═CR¹R² is selected from ═CH(o-CH₃O—C₆H₄) or ═CH(p-CH₃O—C₆H₄)).

In another preferred embodiment of this method, R³ and R⁴ are independently —N(R)₂, preferably pyrrol-1-yl, 2,5-dimethylpyrrol-1-yl, or 2,5-diphenylpyrrol-1-yl, or —OR, wherein R is a six membered or 10 membered aryl ring, optionally substituted, or —OR is C₁₋₄ alkyl such as (CF₃)(CH₃)₂CO, (CF₃)₂(CH₃)CO, (CF₃)₃CO, (C₆H₅)(CF₃)₂C0 or (CH₃)₃CO.

In a further preferred embodiment of this method, R in —OR is phenyl or annelated phenyl substituted with one or more of: C₁₋₄ alkyl, C₁₋₄ alkoxy, optionally substituted phenyl, optionally substituted phenoxy, halogen.

The term “halogen” refers to F, CI, Br, I.

In a further preferred embodiment of this method, ═CR¹R² is selected from ═CHC(CH₃)₃ or ═CHC(CH₃)₂C₆H₅ and R³═R⁴═—OR, wherein R is phenyl or annelated phenyl substituted with one or more of: C₁₋₄ alkyl, C₁₋₄ alkoxy, optionally substituted phenyl, optionally substituted phenoxy, halogen.

In a further preferred embodiment of this method, ═CR¹R² is selected from ═CHC(CH₃)₃ or ═CHC(CH₃)₂C₆H₅ and R³═—OR, wherein R is phenyl or annelated phenyl substituted with one or more of: C₁₋₄ alkyl, C₁₋₄ alkoxy, optionally substituted phenyl, optionally substituted phenoxy, halogen; and R⁴═—N(R)₂, preferably pyrrol-1-yl, 2,5-dimethylpyrrol-1-yl, or 2,5-diphenylpyrrol-1-yl.

Preferably, R in —OR is selected from 2,6-dimethylphenyl, 2,6-diisopropylphenyl, 2,6-ditertiobutylphenyl, 2,6-di-adamantylphenyl, 2,6-dimesitylphenyl, 2,6-di(trifluoromethyl)phenyl, 2,6-dichlorophenyl, 2,6-diphenylphenyl, 2,6-diphenoxyphenyl, pentafluorophenyl, 2-(trifluoromethyl)phenyl, 2,3,5,6-tetraphenylphenyl

Further preferred residues R in —OR are 4-fluoro-2,6-dimesitylphenyl or 2,6-di-tert.-butylphenyl, 4-bromo-2,6-di-tert.-butylphenyl or 4-methoxy-2,6-di-tert.-butylphenyl or 4-methyl-2,6-di-tert.-butylphenyl or 2,4,6-tri-tert.-butylphenyl or 2,3,5,6-tetraphenylphenyl or 4-bromo-2,3,5,6-tetraphenylphenyl or 2,6-di(4-bromophenyl)-3,5-diphenylphenyl or 4-bromo-2,6-di(4-bromophenyl)-3,5-diphenylphenyl.

In one embodiment of of this method, ═CR¹R² is selected from ═CHC(CH₃)₃ or ═CHC(CH₃)₂C₆H₅ and R³═R⁴═—N(R)₂, preferably pyrrol-1-yl, 2,5-dimethylpyrrol-1-yl, or 2,5-diphenylpyrrol-1-yl.

Preferably, the heterogeneous catalysts are stored under an inert gas such as nitrogen or argon prior to the use.

### Exemplification

The above disclosed reaction sequences are now exemplified:

The reaction between known carbyne complex 1 and C₆H₄(o-OMe)C≡CTMS (TMS=trimethyl silane) could be engineered to give 2 (Scheme 1). Addition of one equivalent of water to 3 in the presence of one equivalent of R⁵=PPhMe₂ according to step (A1) led to 3(PPhMe₂) in 34% yield .

A dimeric carbyne complex was obtained in high yield according to step (A2) when 2 reacts with one equivalent of water (in dme=dimethyl ethylene glycol) in the absence of any phosphine at −20° C. to give one equivalent of hexafluoro-t-butanol per Mo and the dimeric carbyne complex 4(dme) (Scheme 1 and Scheme 2).

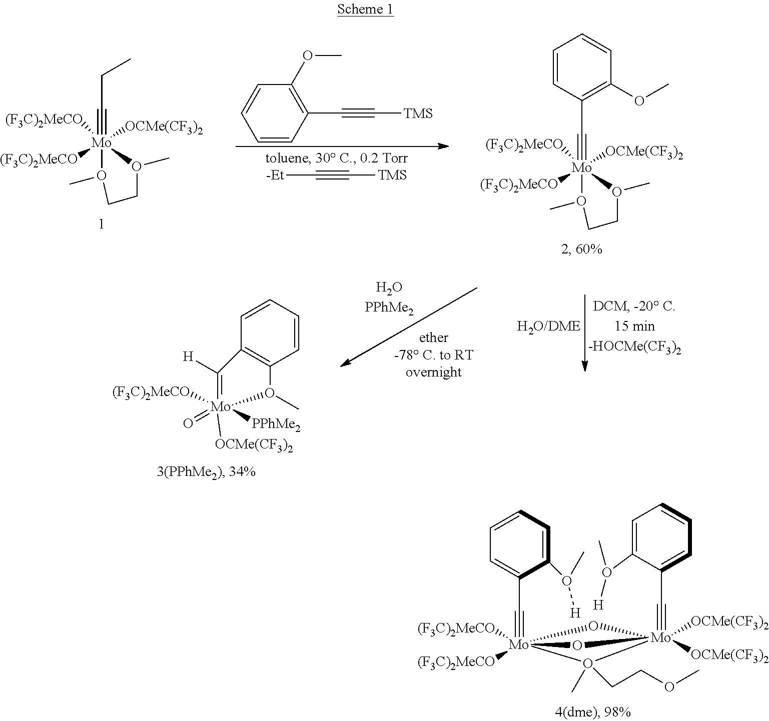

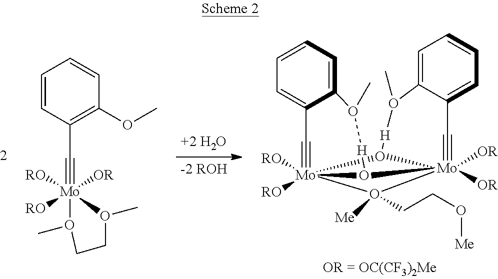

Compound 4 (dme) is a dimeric hydroxy alkylidyne complex (FIG. 2; Mo1-Mo2=3.2164(2) Å), as shown in an X-ray study in which the hydroxy protons (H7 and H8) were located. The benzylidyne ligands are tipped slightly toward the bridging hydroxides (Mo2-C21-C22=167.33(7)°; Mo1-C11-C12=168.57(7)°) and turned so that the methoxy oxygen in each benzylidyne ligand is situated over the oxygen in each bridging hydroxide. The O(alkylidyne) . . . O(hydroxide) distances are 2.904 Å and 2.814 Å, the OH . . . O distances are 2.134 Å and 2.026 Å, and the O—H—O angles are 163.75° and 158.82°. The six-coordinate geometry around each Mo is reached when one oxygen in a dimethoxyethane bridges between the two Mo atoms (Mo—O=2.4743(7) and 2.55 (get) Å).

The subsequent reaction between 4(dme) and PPhMe₂ in pentane gave 3(PPhMe₂) in ˜30% yield, approximately the same yield as in the reaction between 2 and water in the presence of PPhMe₂.

The reaction between 4(dme) and PMe₃ gave 3(PMe₃) (95% by proton NMR). Without being bound by theory, it is believed that in the reaction between 2 and water it seems to be important that only one molecule of water attacks each metal to give 4(dme) before more water reacts with 4(dme). Therefore all water in solution is consumed before a complex mixture of hydrolysis products (e.g., through loss of another hexafluoro-t-butoxide) can be formed. The yield of 3(PMe₃) is highest when approx. five and up to 10 equivalents of PMe₃ per Mo are added to 4(dme).

Addition of HCl to 3(PMe₃) yields 5 (Scheme 3) in 95% yield.

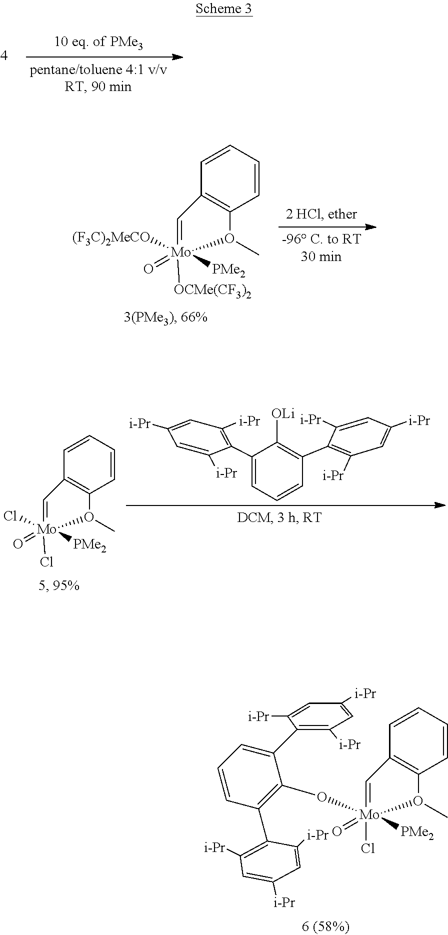

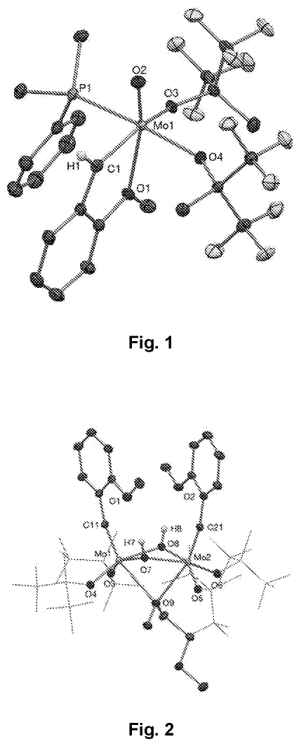

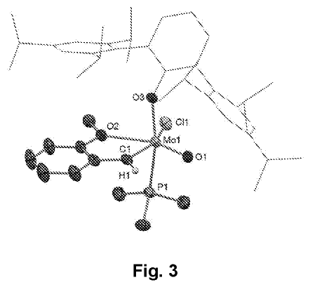

Compound 6 could then be prepared in 58% yield through addition of LiOHIPT to 5. An X-ray study revealed 6 to have the structure shown in FIG. 3 (Mo—O4=1.674(3) Å, Mo—O6=1.982(3) Å, Mo—O5=2.480(2) Å, Mo—Cl2=2.4519(10) Å, Mo—P=2.5133(10) Å, Mo═C═1.974(3) Å). The bond distances are all within the range found in related molybdenum monoaryloxide monochloride phosphine adducts and the Mo1-O2 distance in the anti alkylidene (2.514(2) Å) is close to what it is in 3(PPhMe₂) (2.4740(8) Å; FIG. 1).

According to a third aspect, the invention relates to a method of performing a metathesis reaction of an olefin using the compounds defined in the first aspect or prepared in the method according to the second aspect.

The method comprises step (M):
(M) metathesizing an olefin in the presence of a compound of formula I.

In one embodiment, the method is performed in the presence of a Lewis acid.

In one embodiment, the Lewis acid is B(C₆F₅)₃.

The compound of formula I catalyzes the commonly known metathesis reactions of olefins such as homocoupling (homo-metathesis; HCM)), cross-metathesis (CM), ring opening metathesis (ROM), ring opening polymerization metathesis (ROMP), and acyclic diene metathesis (ADM ET).

Exemplary metathesis activity of complex 6 is listed in Table 3. 6 catalyzes at room temperature ring opening polymerization (ROMP) of cyclooctene, homocoupling of 1-decene, or ROMP of 5,6-dicarbomethoxynorbornadiene (DCMNBD) and 5,6-dicarbomethoxynorbornene (DCMNBE). If two equivalents of B(C₆F₅)₃ are added along with the olefin, reaction is accelerated.

1-decene forms 9-octadecene. Both E and Z 9-octadecene are formed from 1-decene, in part through isomerization of Z to E with time.

Cyclooctene, dicarbomethoxynorbornadiene (DCMNBD), and rac-dicarbomethoxynorbornene (DCMNBE) are polymerized readily at room temperature.

TABLE 3
Catalytic metathesis reactions initiated by 6 in C₆D₆ at 22° C.

| Olefin | 6 (equiv) | B(C₆F₅)₃ | Product |
|---|---|---|---|
| Cyclooctene | 0.05 | 0.1 | >99% poly(COE) |
| 1-Decene ^{a} | 0.01 | 0.02 | 30 m; 57%; 68/32^{b} |
| | | | 18 h; 79%; 55/45 |
| DCMNBD | 0.01 | none | 18 h; 95%; 81/19 |
| | 0.01 | 0.02 | 10 m; >99%; 98/2^{c} |
| rac-DCMNBE | 0.01 | 0.02 | 1 h; >99%; 95/5^{d} |

^{a} Open vial.
^{b}Z/E ratio.
^{c}cis, syndiotactic.
^{d}cis, syndiotactic, alt.

It is important to note that poly(DCMNBD) is >97% cis,syndiotactic, while poly(DCMNBE) is >97% cis, syndiotactic, alt (a cis, syndiotactic structure and a backbone that contains alternating enantiomers). These polymers are essentially identical to analogous polymers made from monoaryloxide pyrrolide Mo or W catalysts that have been reported in the literature. In at least one case, the boron-activated initiator has been shown to produce a more highly structured polymer than in the absence of the Lewis acid. In this vein it should be noted that the poly(DCMNBD) formed in the absence of B(C₆F₅)₃ is less regular than that formed in the presence of B(C₆F₅)₃ (Table 3).

According to a fourth aspect, the invention relates to compounds useful as intermediates in the synthesis of the compounds according to the invention or prepared according to the method of the invention.

In one embodiment, the compound of formula IIa is of structure

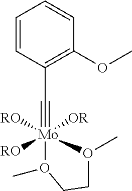

wherein RO is selected from (CF₃)(CH₃)₂CO—, (CF₃)₂(CH₃)CO— or (CF₃)₃CO—.

In a preferred embodiment, the compound of formula IIa is of structure

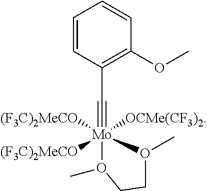

In another embodiment, the intermediate formed in the reaction according to step (A2) is of structure

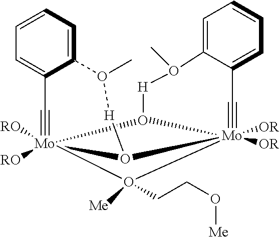

wherein RO is selected from (CF₃)(CH₃)₂CO—, (CF₃)₂(CH₃)CO— or (CF₃)₃CO—.

In a preferred embodiment, the intermediate is of structure

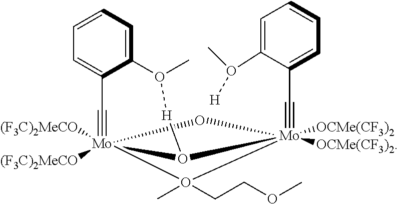

Conclusively, the present disclosure shows that molybdenum oxo alkylidene complexes can be prepared in a controlled fashion from an alkylidyne complex and water. Said molybdenum oxo alkylidene complexes may also be grafted on an oxidic solid support.

The molybdenum oxo alkylidene complexes according to the invention are highly active for metathesis reactions.

Further embodiments of this invention have been published in J. Am. Chem. Soc. 2018, 140, 13609-13613 by F. Zhai et al.

Accordingly, the para-methoxy-benzylidene carbyne complex in the following scheme may be reacted with water and THF to the respective dimeric carbyne complex:

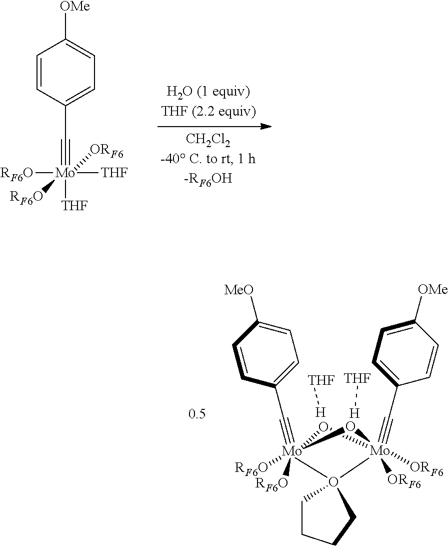

Alternatively, the carbyne complex may be reacted with water in the presence of triethylphosphine to the respective alkylidene complex:

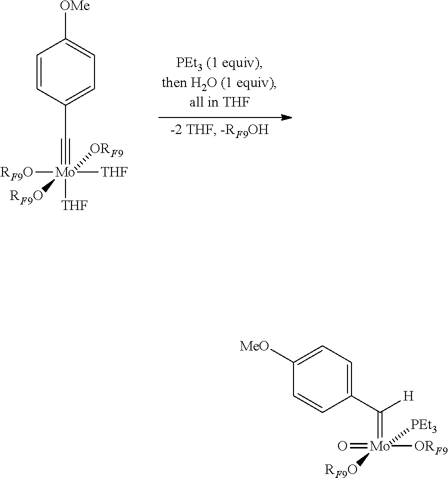

The formed alkylidene complex may be converted with LiOHMT (lithium 2,6-di(2,4,6-trimethylphenyl)phenoxylate) to Mo(═O)(OHMT)₂(═CH(p-CH₃O—C₆H₄)):

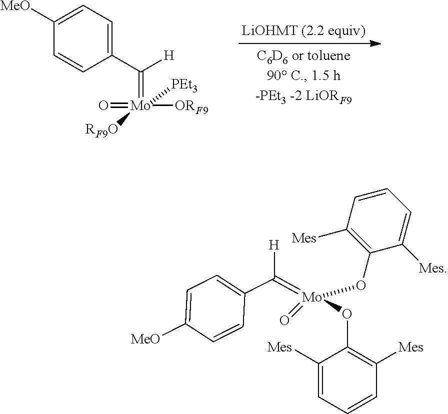

### EXAMPLES

### General Experimental Details

All air- and moisture-sensitive materials were manipulated in a nitrogen-filled Vacuum Atmospheres glovebox or on a dual-manifold Schlenk line. All glassware were oven dried prior to use. Dichloromethane, et₂O, 1,2-dimethoxyethane, and toluene were degassed, passed through activated alumina columns, and stored over 4 Å Linde-type molecular sieves prior to use. Pentane was washed with H₂SO₄, followed by water and saturated aqueous NaHCO₃, and dried over CaCl₂ pellets for at least 2 weeks prior to use in the solvent purification system. Deuterated solvents were dried over 4 Å Linde-type molecular sieves prior to use. ¹H NMR spectra were obtained on 400 or 500 MHz spectrometers and ¹³C NMR spectra on 101, 125 or 151 MHz machines. Chemical shifts for ¹H and ¹³C spectra are reported as parts per million relative to tetramethylsilane and referenced to the residual ¹H or ¹³C resonances of the deuterated solvent (¹H δ: benzene 7.16, chloroform 7.26, methylene chloride 5.32; 13C δ: benzene 128.06, chloroform 77.16, methylene chloride 53.84).

### Starting Materials

PMe₃, PPhMe₂, B(C₆F₅)₃ was purchased from Strem chemicals. HCl (1.00 M solution in ether) was purchased from Aldrich. Cyclooctene and 1-decene were purchased from Alfa Aesar, distilled over CaH₂ and stored over 4 Å Linde-type molecular sieves prior to use. The syntheses of Mo(CEt)[OCMe(CF₃)₂]₃(dme)¹ (1), ((2-methoxyphenyl)ethynyl)trimethylsilane,² 2,3-dicarbomethoxynorbornadiene³ (DCMNBD), rac-endo,exo-5,6-dicarbomethoxynorbornene⁴ (rac-DCMNBE) and 2,6-bis(2,4,6-triisopropylphenyl)phenol⁵ (HOHIPT) were prepared as reported. LiOHIPT was prepared by addition of one equivalent of n-butyllithium to a cold pentane solution of HOHIPT⁵, and the solid was collected on a glass frit, washed with pentane, and dried in vacuo. ¹ Gdula, R. L. and Johnson, M. J. A. J. Am. Chem. Soc. 2006, 128, 9614-9615.² Huang, Q. and Larock, R. C. J. Org. Chem. 2003, 68, 980-988.³ Tabor, D. C.; White, F. H.; Collier, L. W.; Evans, S. A. J. Org Chem. 1983, 48, 1638.⁴ Flook, M.; Ng, V.; and Schrock, R. J. Am. Chem. Soc., 2011, 133, 1784-1786.⁵ Koh, M. J.; Nguyen, T. T.; Lam, J.; Torker, S.; Hyvl, J.; Schrock, R. R.; Hoveyda, A. H. Nature 2017, 542, 80-85.

### Syntheses of Monometallic Complexes

### Mo[C(2-(MeO)C₆H₄)][OCMe(CF₃)₂]₃(dme), 2

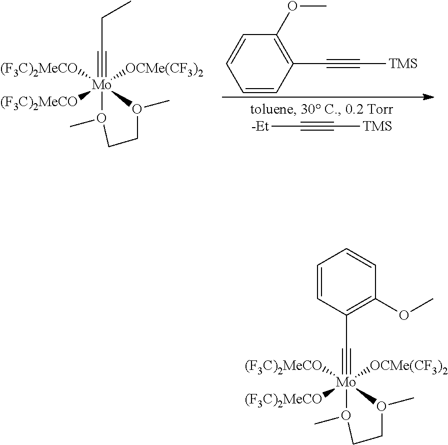

A solution of Mo(CEt)[OCMe(CF₃)₂]₃(dme)¹ (1) (5.00 g, 6.49 mmol, 1 eq.) and ((2-methoxyphenyl)ethynyl)trimethylsilane² (1.46 g, 7.14 mmol, 1.1 eq.) in 20 mL of toluene was stirred at 30° C. under vacuum (0.2 Torr) until all volatiles were removed. Toluene (20 mL) was added and procedure was repeated 3 more times (total 4 times). The residue was dissolved in 20 mL of dichloromethane and filtered through Celite. The resulting dark red solution was kept at −20° C. overnight to produce large red crystals of Mo[C(2-(MeO)C₆H₄)][OCMe(CF₃)₂]₃(dme) (2) (3.6 g, 65%): ¹H NMR (500 MHz; C₆D₆) δ 7.27 (d, J=7.7 Hz, 1H), 6.68 (t, J=7.8 Hz, 1H), 6.61 (t, J=7.6 Hz, 1H), 6.22 (d, J=8.3 Hz, 1H), 3.32 (s, 6H), 3.10 (s, 4H), 3.08 (s, 3H), 1.88 (s, 9H); ¹⁹F NMR (282 MHz; C₆D₆) δ −76.9; 2-12-17; ¹³C NMR (151 MHz; C₆D₆) δ 292.2, 159.8, 133.6, 133.3, 130.9, 124.8 (q, J_{CF}=290 Hz), 120.1, 110.8, 84.03 (m, J_{CF}=28 Hz), 71.7, 63.7, 53.9, 18.3. Anal. Calcd for C₂₄H₂₆F₁₈MoO₆ (848.40 g/mol): C, 33.98%; H, 3.09%. Found: C, 33.91%; H, 2.80%.

### Mo(O)[CH(2-(MeO)C₆H₄)][OCMe(CF₃)₂]₂(PPhMe₂), 3(PPhMe₂)

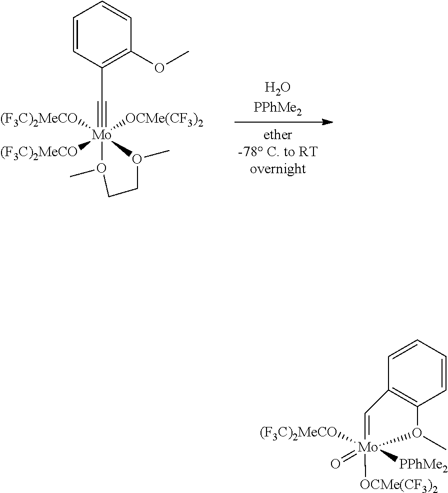

Water (10 μL, 10 mg, 0.556 mmol, 1 eq.) was added to the solution of Mo[C(2-(MeO)C₆H₄)][OCMe(CF₃)₂]₃(dme) (2) (471 mg, 0.556 mmol, 1eq.) and PPhMe₂ (76.7 mg, 0.556 mmol, 1 eq.) in 20 mL of ether at −78° C. using micro syringe. The resulting solution was stirred in the same cooling bath for 16 hours and the mixture was allowed to warm up slowly. All volatiles were removed in vacuo and the residue was crystallized in pentane at −20° C. to give Mo(O)[CH(2-(MeO)C₆H₄)][OCMe(CF₃)₂]₂ (PPhMe₂) (3(PPhMe₂)) (140 mg, 34%) as orange crystals: ¹H NMR (400 MHz; C₆D₆) δ 13.24 (d, J_{PH}=7.2 Hz, J_{CH}=140 Hz, 1H), 6.90-6.76 (m, 5H), 6.61-6.56 (m, 2H), 6.09-6.06 (m, 1H), 5.87-5.85 (m, 1H), 3.32 (s, 3H), 2.20 (s, 3H), 1.24 (s, 3H), 1.20 (d, J_{PH}=9.4 Hz, 3H), 1.10 (d, J_{PH}=9.9 Hz, 3H); ¹⁹F NMR (376 MHz; C₆D₆) δ −76.74 (q, J=9.4 Hz, 3F), −76.93 (m, 6F), −77.4 (q, J=9.4 Hz, 3F); ³¹P NMR (162 MHz; C₆D₆) δ 4.5; ¹³C NMR (101 MHz; C₆D₆) δ 280.6 (dd, J=21 Hz, J=11 Hz), 160.45, 134.1, 133.7, 132.61, 132.55, 132.46, 129.77, 129.68, 128.19, 127.3, 126.6, 124.4, 123.8, 122.4, 121.3, 109.1, 82.20-80.2 (m), 55.2, 18.2, 17.9, 13.2 (d, J_{CP}=25 Hz), 10.2 (d, J_{CP}=23 Hz). Anal. Calcd for C₂₄H₂₅F₁₂MoO₄P (732.37 g/mol): C, 39.36%; H, 3.44%. Found: C, 39.37%; H, 3.29%. Crystals of 3(PPhMe₂) suitable for X-ray data collection were obtained through crystallization from pentane at −20° C.

### {Mo[CH(2-(MeO)C₆H₄)][OCMe(CF₃)₂]₂(μ—OH)}₂(dme), 4(dme)

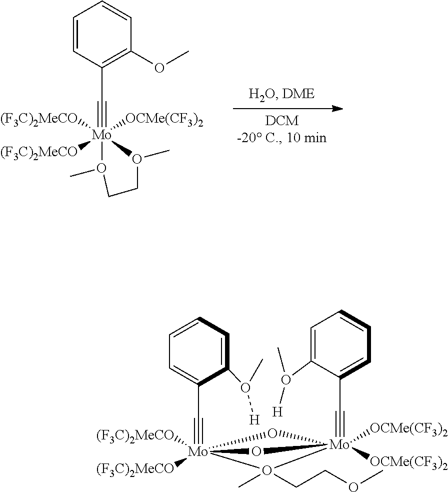

A solution of water (106 μL, 0.106 g, 5.89 mmol, 1 eq.) in 2 mL of DME was added to the cold solution of Mo[C(2-(MeO)C₆H₄)][OCMe(CF₃)₂]₃(dme) (2) (5.00 g, 5.89 mmol, 1 eq.) in 150 mL of dichloromethane at −20° C. The resulting solution was stirred at RT for 10 minutes, during this time red dark solution became orange suspension. All volatiles were removed in vacuo and the residue was washed by pentane and filtered off to produce {Mo[CH(2-(MeO)C₆H₄)][OCMe(CF₃)₂]₂(μ—OH)}₂(dme) (4(dme)) (3.76 g, 98%) as an orange powder: ¹H NMR (400 MHz; CD₂Cl₂) δ 9.30 (s, 2H), 7.10 (ddd, J=8.6, 7.3, 1.5 Hz, 2H), 7.01 (dd, J=7.7, 1.6 Hz, 2H), 6.89 (td, J=7.5, 0.7 Hz, 2H), 6.52 (d, J=8.4 Hz, 2H), 3.72 (s, 4H), 3.36 (s, 6H), 3.14 (s, 6H), 1.90 (s, 12H); ¹⁹F NMR (376 MHz; CD₂Cl₂) δ −77.2 (m, 12F), −77.9 (m, 12F); ¹³C NMR (101 MHz; CD₂Cl₂) δ 290.2, 166.1, 132.2, 131.3, 129.2, 124.1 (q, J_{CF} =289 Hz), 124.0 (q, J_{CF}=289 Hz), 83.0 (m, J_{CF}=28 Hz), 73.4, 60.0, 55.6, 19.4. Anal. Calcd for C₃₆H₃₈F₂₄Mo₂O₁₀ (1278.57 g/mol): C, 33.82%; H, 3.00%. Found: C, 33.72%; H, 2.68%. Crystals of 4(dme) suitable for X-ray data collection were obtained through crystallization from dichloromethane at −20° C.

### Mo(O)[CH(2-(MeO)C₆H₄)][OCMe(CF₃)₂]₂(PMe₃), 3(PMe₃)

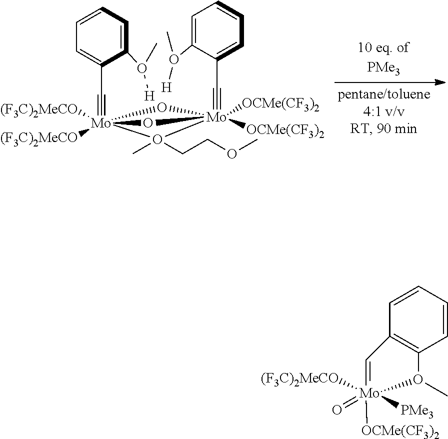

PMe₃ (3.0 mL, 29.40 mmol, 10 eq.) was added to suspension of {Mo[CH(2-(MeO)C₆H₄)][OCMe(CF₃)₂]₂(μ—OH)}₂(dme) (4(dme)) (3.76 g, 2.94 mmol, 1 eq.) in 100 mL of mixture pentane/toluene (4:1, v/v) at RT for 1.5 hours. During this time the starting material dissolved and crude product precipitated as a yellow powder. Crude product (1.3 g) was filtered off and the solution was kept at −20° C. for 1 hour to produce 1.5 g of pure product 3(PMe₃) as orange crystals. The mother liquor was used to recrystallize crude product, which gives additionally 1.1 g of Mo(O)[CH(2-(MeO)C₆H₄)][OCMe(CF₃)₂]₂(PMe₃) (3(PMe₃)) (total 2.6 g, 66%): ¹H NMR (400 MHz; C₆D₆) δ 13.42 (d, J_{PH}=7.3 Hz, J_{CH}=142 Hz, 1H), 6.71-6.67 (m, 2H), 6.34-6.30 (m, 1H), 6.15-6.12 (m, 1H), 3.53 (s, 3H), 2.19 (s, 3H), 1.28 (s, 3H), 0.71 (d, J_{PH}=9.9 Hz, 9H); ¹⁹F NMR (376 MHz; C₆D₆) δ −76.81 (q, J=9.4 Hz, 3F), −76.93 (q, J=9.4 Hz, 3F), −77.3 (q, J=9.4 Hz, 3F), −77.5 (q, J=9.4 Hz, 3F); ³¹P NMR (162 MHz; C₆D₆) δ −2.7. ¹³C NMR (101 MHz; C₆D₆): δ 278.5 (dd, J=22 Hz, J=12 Hz), 160.6, 132.80, 132.61, 127.52, 127.33, 126.9, 126.6, 124.7, 124.4, 124.0, 123.8, 122.5, 121.8, 109.3, 80.6 (m), 55.5, 18.2, 17.9, 13.1 (d, J_{CO}=28 Hz). Anal. Calcd for C₁₉H₂₃F₁₂MoO₄P (670.30 g/mol): C, 34.05%; H, 3.46%. Found: C, 34.01%; H, 3.21%.

### Mo(O)[CH(2-(MeO)C₆H₄)]Cl₂(PMe₃), 5

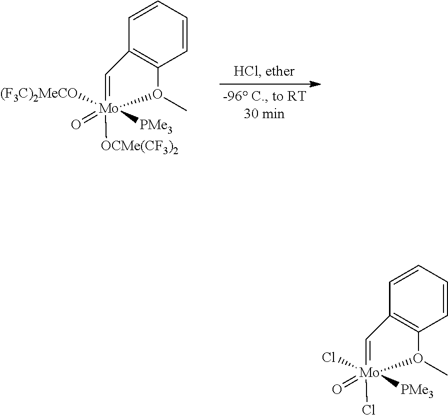

HCl (8.15 mL, 1.00 M solution in ether, 8.15 mmol, 2.1 eq.) was added to solution of Mo(O)[CH(2-(MeO)C₆H₄)][OCMe(CF₃)₂]₂(PMe₃) (3(PMe₃)) (2.6 g, 3.88 mmol, 1 eq.) in 30 mL of ether at −96° C. (dichloromethane/liquid N₂ cooling bath) under nitrogen. A yellow precipitate formed immediately. The cooling bath was removed and the resulting suspension was stirred at RT for 30 minutes to produce orange precipitate. The product was filtered off, washed with 20 mL of ether and dried in vacuo to produce Mo(O)[CH(2-(MeO)C₆H₄)]Cl₂(PMe₃) (5) (1.4 g, 95%) as an orange powder. 5 decomposes in the solution at RT during few hours and has to be kept as a solid at −20° C.: ¹H NMR (500 MHz; CD₂Cl₂) δ 14.52 (d, J_{PH}=5.7 Hz, J_{CH}=143 Hz, 1H), 7.28 (t, J=7.9 Hz, 1H), 7.11 (t, J=7.4 Hz, 1H), 7.03 (d, J=8.3 Hz, 1H), 6.81 (d, J=7.6 Hz, 1H), 4.04 (s, 3H), 1.44 (d, J_{PH}=10.8 Hz, 9H); ³¹P NMR (162 MHz; C₆D₆) δ 4.7; ¹³C NMR (151 MHz; CD₂Cl₂) δ 288.5 (m), 161.6, 135.0, 132.45, 124.2, 122.6, 111.1, 58.0, 14.58 (d, J_{CP}=30 Hz). Anal. Calcd for C₁₁H₁₇Cl₂MoO₂P (379.09 g/mol): C, 34.85%; H, 4.52%. Found: C, 34.85%; H, 4.33%.

### Mo(O)[CH(2-(MeO)C₆H₄)](OHIPT)CI(PMe₃), 6

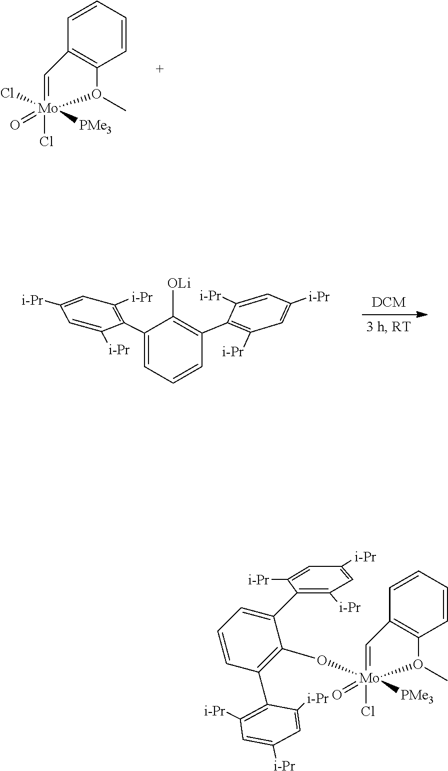

LiOHIPT (665 mg, 1.32 mmol, 1 eq.) was added to solution of Mo(O)[CH(2-(MeO)C₆H₄)]Cl₂(PMe₃) (5) (500 mg, 1.32 mmol, 1 eq.) at RT. The resulting solution was stirred at RT for 3 hours. All volatiles were removed in vacuo, the residue was stirred in 20 mL of pentane for 10 minutes and filtered through Celite. The resulting dark red solution was kept at −20° C. for 24 hours to produce red crystals of Mo(O)[CH(2-(MeO)C₆H₄)](OHIPT)Cl(PMe₃) (6) (610 mg, 58%): ¹H NMR (500 MHz; C₆D₆) δ 13.34 (d, J_{PH}=6.9 Hz, J_{CH}=142 Hz, 1H), 7.31 (s, 2H), 7.27 (d, J=7.4 Hz, 2H), 7.13 (s, 2H), 6.99 (t, J=7.4 Hz, 1H), 6.71-6.66 (m, 2H), 6.37-6.35 (m, 1H), 6.24-6.22 (m, 1H), 3.59-3.42 (m, 4H), 2.94 (dquintet, J=13.8, 6.9 Hz, 2H), 2.82 (s, 3H), 1.60 (d, J=6.8 Hz, 6H), 1.36 (d, J=6.9 Hz, 12H), 1.29 (d, J=6.8 Hz, 6H), 1.20 (d, J=6.8 Hz, 6H), 1.17 (d, J=6.8 Hz, 6H), 0.58 (d, J_{PH}=10.0 Hz, 9H); ³¹P NMR (162 MHz; C₆D₆) δ −0.03; ¹³C NMR (101 MHz; C₆D₆) δ 273.15 (m), 161.5, 160.0, 148.7, 148.32, 148.13, 146.9, 137.6, 133.55, 133.48, 132.3, 131.9, 131.1, 130.5, 122.3, 121.52, 121.39, 121.0, 120.8, 120.5, 118.2, 109.3, 56.4, 34.9, 31.2, 30.9, 26.6, 26.2, 24.77, 24.62, 24.3, 23.1, 14.0 (d, J_{CP}=27 Hz). Anal. Calcd for Mo(O)[CH(2-(MeO)C₆H₄)](OHIPT)Cl(PMe₃)*0.5(n-C₅H₁₂), C_{49.5}H₇₂ClMoO₃P (877.50 g/mol): C, 67.75%; H, 8.27%. Found: C, 67.85%; H, 8.34%. Crystals of 6 suitable for X-ray data collection were obtained through crystallization from pentane at −20° C.

### Catalytic Experiments

### Ring Opening Metathesis Polymerization (ROMP) of Cyclooctene

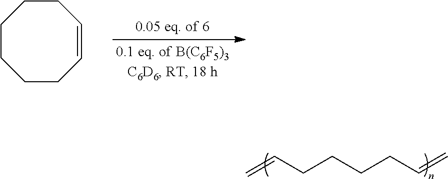

Cyclooctene (3.1 μL, 2.6 mg, 23.8 μmol, 20 eq.) was added to solution of Mo(O)[CH(2-MeO)C₆H₄](OHIPT)(Cl)(PMe₃) (1 mg, 1.2 μmol, 1 eq.) and B(C₆F₅)₃ (1.2 mg, 2.4 μmol, 2 eq.) in 0.1 mL of C₆D₆at RT using micro syringe. The solution was stirred at RT for 18 hours, diluted with 0.5 mL of C₆D₆ and analyzed by proton NMR. Conversion to polycyclooctene is >99%. Conversion was estimated by integration olefin proton resonance of cyclooctene (m, 5.69-5.61 ppm) and polycyclooctene (m, 5.51-5.45 ppm). The same reaction in the absence of B(C₆F₅)₃ gives <1% conversion to polycyclooctene.

### Homocoupling of 1-decene

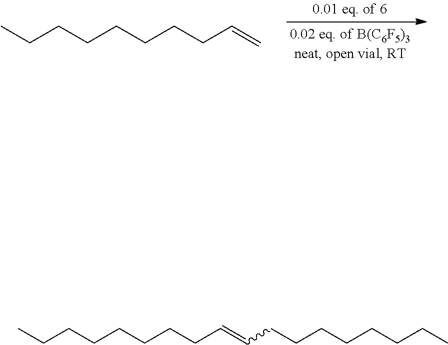

1-decene (112.6 μL, 83.4 mg, 594.2 μmol, 100 eq.) was added to the mixture of Mo(O)[CH(2-MeO)C₆H₄](OHIPT)(Cl)(PMe₃) (5 mg, 5.9 μmol, 1 eq.) and B(C₆F₅)₃ (6.1 mg, 11.9 μmol, 2 eq.) at RT using micro syringe. The resulting mixture was stirred at RT in open vial. Aliquots were taken, diluted with 0.6 mL of CDCl₃ and analyzed by ¹H NMR. Conversion was estimated by integration olefin proton resonance of 1-decene (m, 5.86-5.78) and 9-octadecene (m, 5.39-5.32). The Z/E ratio was estimated by integration olefin proton resonance of E-9-octadecene (m, 5.39-5.37) and Z-9-octadecene (m, 5.37-5.32).

TABLE 4
Conversion of 1-decene to 9-octadecene and Z/E ratio of the product.

| Time | 20 minutes | 2 hours | 18 hours |
|---|---|---|---|
| Conversion, % | 57 | 79 | 84 |
| Z/E | 68/32 | 58/42 | 55/45 |

### ROMP of 2,3-dicarbomethoxynorbornadiene (DCMNBD)

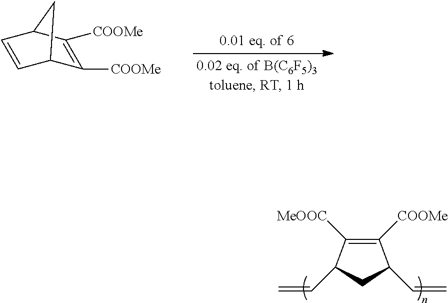

Solution of Mo(O)[CH(2-MeO)C₆H₄](OHIPT)(Cl)(PMe₃) (5 mg, 5.9 μmol, 1 eq.) in 0.5 mL of toluene was added to the solution of DCMNBD³ (124 mg, 594.2 μmol, 100 eq.) and B(C₆F₅)₃ (6.1 mg, 11.9 μmol, 2 eq.) in 1.5 mL of toluene at RT. White poly(DCMNBD) started to precipitate immediately. The reaction mixture was stirred for 1 hour and poured into 100 mL of methanol. The polymer was filtered off, washed with methanol and dried in vacuo to give white poly(DCMNBD) (115 mg, 93%). ¹H NMR (400 MHz; CDCl₃): δ 5.37-5.31 (m, 2H), 4.02-3.97 (m, 2H), 3.73 (s, 6H), 2.57-2.50 (m, 1H), 1.49-1.43 (m, 1H). ¹³C NMR (101 MHz; CDCl₃): δ 165.5, 142.4, 131.6, 52.1, 44.6, 38.1. Data corresponds to cis-syndiotactic poly(DCMNBD).⁶ ⁶ Flook, M.; Jiang, A.; Schrock, R.; Muller, P.; and Hoveyda A. J. Am. Chem. Soc., 2009, 131, 7962-7963.

### ROMP of rac-endo,exo-5,6-dicarbomethoxynorbomene (rac-DCMNBE)

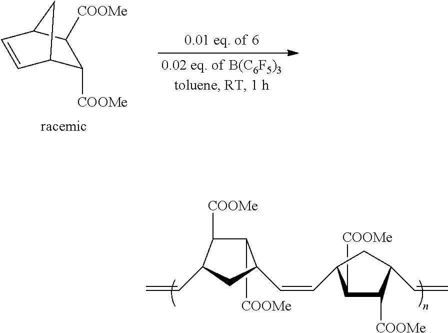

Solution of Mo(O)[CH(2-MeO)C₆H₄](OHIPT)(Cl)(PMe₃) (5 mg, 5.9 μmol, 1 eq.) in 0.5 mL of toluene was added to the solution of rac-DCMNBE⁴ (125 mg, 594.2 μmol, 100 eq.) and B(C₆F₅)₃ (6.1 mg, 11.9 μmol, 2 eq.) in 1.5 mL of toluene at RT. White poly(rac-DCMNBE) started to precipitate after a few minutes. The reaction mixture was stirred for 1 hour and poured into 100 mL of methanol. The polymer was filtered off, washed with methanol and dried in vacuo to give white poly(rac-DCMNBE) (120 mg, 96%). ¹H NMR (400 MHz; CDCl₃): δ 5.37-5.31 (m, 1H), 5.25-5.20 (m, 1H), 3.66 (s, 3H), 3.61 (s, 3H), 3.36-3.26 (m, 2H), 3.13-2.95 (m, 2H), 2.10-2.07 (m, 1H), 1.40-1.32 (m, 1H). ¹³C NMR (101 MHz; CDCl₃): δ 174.2, 172.9, 133.0, 130.8, 52.7, 52.3, 52.1, 51.8, 42.1, 40.6, 39.1. Data corresponds to cis-syndio, alt poly(rac-DCMNBE).⁴

### X-Ray Structural Studies

Low-temperature diffraction data were collected on a Bruker-AXS X8 Kappa Duo diffractometer coupled to a SMART Apex2 CCD detector or a Bruker-AXS D8 Venture Duo diffractometer coupled to a Bruker-AXS Photon II CPAD detector with Mo K_{α} radiation (λ=0.71073 Å) from an 1 μS micro-source, performing ϕ- and ω-scans. The structures were solved by direct methods using SHELXT⁷ and refined against F² on all data by full-matrix least squares with SHELXL-2014⁸ following established refinement strategies⁹. All non-hydrogen atoms were refined anisotropically. Except where specified for alkylidene hydrogen atoms, all hydrogen atoms were included into the model at geometrically calculated positions and refined using a riding model. The isotropic displacement parameters of all hydrogen atoms were fixed to 1.2 times the U value of the atoms they are linked to (1.5 times for methyl groups). ⁷ Sheldrick, G. M. Acta Cryst. 2015, A71, 3-8.⁸ Sheldrick, G. M., Acta Cryst. 2015, C71, 3-8.⁹ Milder, P. Crystallography Reviews 2009, 15, 57-83.

Compound Mo(O)[CH(2-(MeO)C₆H₄)][OCMe(CF₃)₂]₂(PPhMe₂) (3(PPhMe₂)) crystallizes in the triclinic centrosymmetric space group P1̅ with one molecule of Mo(O)[CH(2-(MeO)C₆H₄)][OCMe(CF₃)₂]₂(PPhMe₂) (3(PPhMe₂)) in the asymmetric unit. The alkylidene hydrogen was located in the difference map and refined semi-freely with the help of a distance restraint.

Compound {Mo[CH(2-(MeO)C₆H₄)][OCMe(CF₃)₂]₂(μ—OH)}₂(dme) (4(dme)) crystallizes in the monoclinic centrosymmetric space group P2₁/n with one molecule of {Mo[CH(2-(MeO)C₆H₄)][OCMe(CF₃)₂]₂(μ—OH)}₂(dme) (4(dme)) per asymmetric unit. The hydrogen atoms on the bridging hydroxides was located in the difference map and refined semi-freely with the help of a distance restraint.

The structure exhibited one disordered alkoxide group, which was modeled over two positions, and a disordered bridging dimethoxyethane ligand, which was modeled over three positions. All disorders were refined with the help of similarity restraints on 1,2- and 1,3-distances as well as similarity and rigid bond restraints for anisotropic displacement parameters; additionally, the anisotropic displacement parameters of all three positions of one atom involved in the three-part disorder were constrained to be equal.

Compound Mo(O)[CH (2-(MeO)C₆H₄)](OHIPT)Cl(PMe₃) (6) crystallizes in the monoclinic centrosymmetric space group P2₁/c with two molecules of Mo(O)[CH(2-(MeO)C₆H₄)](OHIPT)Cl(PMe₃) (6) and two molecules of pentane per asymmetric unit. The structure was refined as a two-component pseudo-merohedral twin with a freely-refined twin ratio of 79:21. The alkylidene hydrogen was located in the difference map and refined semi-freely with the help of a distance restraint. Both pentane molecules were disordered over two positions and were refined with the help of similarity restraints on 1,2- and 1,3-distances as well as similarity and rigid bond restraints for anisotropic displacement parameters.

1. A compound of formula I: 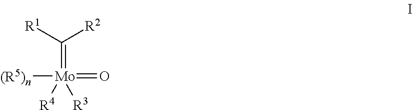
wherein:
one of R¹ and R² is H and the other is an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each of R³ and R⁴ is independently halogen, R, —N(R)₂, —NRC(O)R, —NRC(O)OR, —NRC(O)N(R)₂, —NRSO₂R, —NRSO₂N(R)₂, —NROR, —OR, or an optionally substituted group selected from a 5-6 membered monocyclic heteroaryl ring having at least one nitrogen and 0-3 additional heteroatoms independently selected from nitrogen, oxygen, or sulfur, a 4-7 membered saturated or partially unsaturated heterocyclic ring having at least one nitrogen and 0-2 additional heteroatoms independently selected from nitrogen, oxygen, or sulfur, a 7-10 membered bicyclic saturated or partially unsaturated heterocyclic ring having at least one nitrogen and 0-4 additional heteroatoms independently selected from nitrogen, oxygen, or sulfur, or an 8-10 membered bicyclic heteroaryl ring having at least one nitrogen and 0-4 additional heteroatoms independently selected from nitrogen, oxygen, or sulfur; or
two R groups on the same nitrogen atom are taken together with the nitrogen to form an optionally substituted 3-12 membered saturated, partially unsaturated, or aryl ring having 0-5 additional heteroatoms not including the same nitrogen atom independently selected from nitrogen, oxygen, or sulfur; or:
each R is independently hydrogen or an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2; or
one of R³ or R⁴ is a covalent bond linking Mo to an oxidic solid support.

2. The compound of claim 1, wherein one of R¹ and R² is —C(CH₃)₃, —C(CH₃)₂C₆H₅ or optionally substituted phenyl.

3. The compound of claim 1 or 2, wherein one of R¹ and R² is optionally substituted phenyl bearing in o-position or p-position a —O—R⁷ residue, wherein
R⁷=C₁₋₈ alkyl, optionally substituted, wherein preferred optional substituents in R⁷=C₁₋₈ alkyl are one or more of halogen, cyano, C₁₋₈ alkyl, C₁₋₈ alkoxy or phenyl, further preferably wherein substituted C₁₋₈ alkyl is fluorine-substituted C₁₋₈ alkyl such as perfluoro C₁₋₈ alkyl such as trifluoromethyl, C(CH₃)(CF₃)₂ or C(CF₃)₃; or
wherein optional substituents may be selected from carboxylic esters C(O)OR⁸, wherein R⁸=C₁₋₈ alkyl or phenyl; or
wherein optional substituents are C(O)NHOR⁸, wherein R⁸=C₁₋₈ alkyl or phenyl, or C(OR⁸)NOR⁸, wherein R⁸ independently from each other have the meaning of C₁₋₈ alkyl or phenyl; or
wherein preferred optional substituents are amides C(O)NHR⁸, wherein R⁸=C₁₋₈ alkyl or phenyl, and amides C(O)N(R⁸)₂, wherein R⁸ independently from each other have the meaning of C₁₋₈ alkyl or phenyl; or
wherein R⁷=CHR⁸COOR⁸, CHR⁸C(O)NHOR⁸, CHR⁸C(OR⁸)NOR⁸, CHR⁸C(O)NHR⁸, or CHR⁸C(O)N(R⁸)₂, wherein R⁸ independently from each other have the meaning of C₁₋₈ alkyl or phenyl; or
wherein R⁷=C₆₋₁₀ aryl such as phenyl, optionally substituted, preferably wherein substituents in R⁷=aryl such as phenyl are one or more of halogen, cyano, C₁₋₈ alkyl, C₁₋₈ alkoxy or phenyl, further preferably wherein substituted phenyl is e.g. C₆F₅.

4. The compound of any one of claims 1 to 3, wherein each of R³ and R⁴ is independently halogen, —N(R)₂, or —OR.

5. The compound of any one of claims 1 to 4, wherein each of R³ and R⁴ is independently halogen, preferably chlorine.

6. The compound of any one of claims 1 to 4, wherein one of R³ and R⁴ is halogen and the other is OR.

7. The compound of any one of claims 1 to 4, wherein each of R³ and R⁴ is independently —OR.

8. The compound of claim 6 or 7, wherein —OR is —O-aryl, wherein aryl may be substituted.

9. The compound of claim 8, wherein —O-aryl is selected from: 2,6-(diphenyl)phenoxy, 2,6-di(2,4,6-trimethylphenyl)phenoxy, 2,6-di(2,4,6-triethylphenyl)phenoxy, 2,6-di(2,4,6-triisopropylphenyl)phenoxy, 2,6-di(2,4,6-tri-t-butylphenyl)phenoxy, 2,6-di(2,4,6-triphenyl)phenoxy, 2,6-di(3,5-di-t-butylphenyl)phenoxy, 2,6-di(pentafluorophenyl)phenoxy, 2,3,5,6-tetra(phenyl)phenoxy 4-bromo-2,3,5,6-tetra(phenyl)phenoxy, 4-nitro-2,3,5,6-tetra(phenyl)phenoxy, 4-amino-2,3,5,6-tetra(phenyl)phenoxy, and 4-cyano-2,3,5,6-tetra(phenyl)phenoxy; or
2,6-di(2,6-dimethylphenyl)phenyl, 2,6-di(2,6-diethylphenyl)phenyl, 2,6-di(2,6-diisopropylphenyl)phenyl, 2,6-di(2,6-di-t-butylphenyl)phenyl, and 2,6-di(2,6-diphenyl)phenyl.

10. The compound of any one of claims 6 to 7, wherein —OR is selected from (CF₃)(CH₃)₂CO—, (CF₃)₂(CH₃)CO—, (CF₃)₃CO—,

11. The compound of any one of claims 1 to 4, wherein one of R³ and R⁴ is halogen and the other is —N(R)₂.

12. The compound of any one of claims 1 to 4, wherein each of R³ and R⁴ is independently —N(R)₂.

13. The compound of claim 11 or 12, wherein —N(R)₂ is selected from pyrrol-1-yl, 2,5-dimethylpyrrol-1-yl or 2,5-diphenylpyrrol-1-yl.

14. The compound of any one of claims 1 to 4, wherein one of R³ and R⁴ is —OR and the other is —N(R)₂.

15. The compound of any one of the preceding claims, wherein R⁵ is selected from an ether, a nitrile, a pyridine or a phosphine.

16. The compound of claim 15, wherein R⁵ is a phosphine.

17. The compound of claim 16, wherein the phosphine is of formula P(R⁶)₃, wherein R⁶ is independently selected from C₁₋₆ alkyl, C₃₋₆cycloalkyl, and phenyl.

18. The compound of any one of claims 15 to 17, wherein R⁵ is trimethylphosphine, triethylphosphine, triisopropylphosphine, tricyclohexylphosphine, dimethylphenylphosphine or diphenylmethylphosphine.

19. The compound of any one of claims 1 to 3, wherein the solid support is an oxide of silicon, aluminum, titanium, vanadium, molybdenum, tungsten or a mixture of two or more thereof.

20. The compound of claim 19, wherein the solid support comprises or consists of an oxide of silicon.

21. The compound claim 10, wherein the compound has the structure

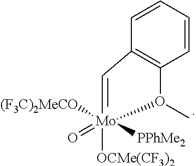

22. The compound of claim 5, wherein the compound has the structure

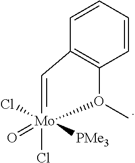

23. The compound of claim 9, wherein the compound has the structure

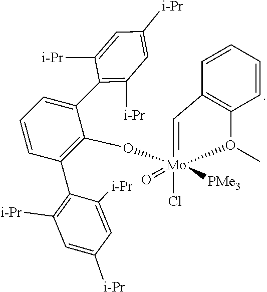

24. A method of making a compound of formula I, comprising step (A):
(A) reacting an alkylidyne complex of formula II 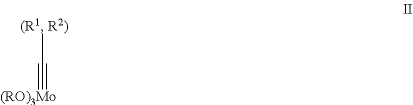
with water;
wherein R¹ or R² and R have the meaning as defined in any one of claims 1 to 23 with respect to the compound of formula I.

25. The method of claim 24, wherein the compound of formula II is provided in the form of II(dimethyl ethylene glycol); or
wherein the compound of formula II is provided in the form of II(dimethyl ethylene glycol), and —OR is (CF₃)₂(CH₃)CO—, respectively.

26. The method of claim 24 or 25, wherein step (A) comprises step (A1):
(A1) reacting an alkylidyne complex of formula II [such as II(dme), II(et₂O)_{1 or 2} and II(THF)_{1 or 2}] in the presence of neutral ligand R⁵ with water to afford a compound of formula I (R⁵)ₙ(OR)₂Mo(O)(CR¹R²) wherein n, R¹, R², R and R⁵ have the meaning as defined in any one of claims 1 to 23 or claim 25.

27. The method of claim 24 or 25, wherein step (A) comprises step (A2):
(A2) reacting an alkylidyne complex of formula II [such as II(dme), II(et₂O)_{1 or 2} or II(THF)_{1 or 2}] in the absence of R⁵ with water in the presence of an ether as solvent, and subsequently reacting the formed reaction product [(RO)₂(Mo≡—(R₁,R₂)(—O—)₂(RO)₂(Mo≡—(R₁,R₂)]ether (ether=dme, et₂O or THF) with R⁵ to afford a compound of formula I (R⁵)ₙ(OR)₂Mo(O)(CR¹R²) wherein n, R¹, R², R and R⁵ have the meaning as defined in any one of claims 1 to 23 or claim 25.

28. The method of any one of claims 24 to 27, wherein the compound defined in claim 7 is reacted with hydrogen halogenide to afford a compound as defined in claim 5.

29. The method of claim 28, wherein the compound defined in claim 5 is reacted with
(B) RO⁻ to afford a compound as defined in claim 6 or 7; or
(C) N(R)₂⁻ to afford a compound as defined in claim 11 or 12; or
(D) RO⁻ and N(R)₂⁻ to afford a compound as defined in claim 14.

30. Method of any one of claims 25 to 29, further comprising prior to step (A) step (O):
(O) reacting a compound of formula II with a compound of formula III to afford a compound of formula IIa: 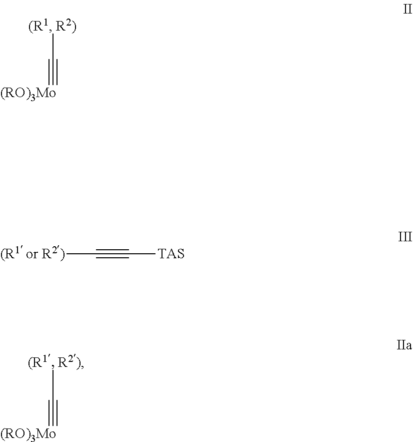
wherein TAS has the meaning of a trialkylsilane, and R^{1′} or R^{2′} have the meaning as defined for R¹ or R² but are not identical to R¹ and R².

31. The method of any one of claims 24 to 30, wherein
the compound of formula II has the structure 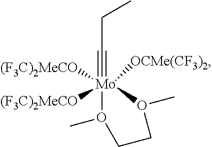
the compound of formula III has the structure 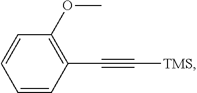
the compound of formula IIa has the structure 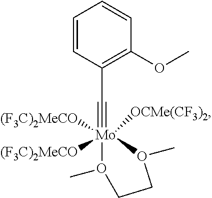
the compound formed in the reaction as defined in claim 26 has the structure 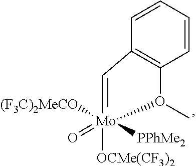
the compound formed in the reaction with water in presence of dme as solvent as defined in claim 27 has the structure 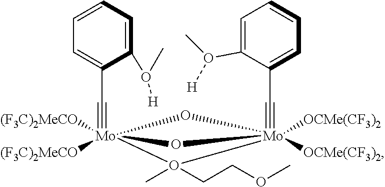
the compound formed in the reaction as defined in claim 28 has the structure 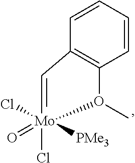
and
wherein the compound formed in the method as defined in claim 29 (B) has the structure

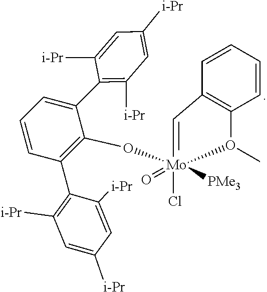

32. The method of any one of claims 24 to 31, further comprising step (E):
(E) reacting a compound as defined in any one of claims 1 to 23 with an oxidic solid support.

33. A method of performing a metathesis reaction, comprising step (M):
(M) metathesizing an olefin in the presence of a compound as defined in any one of claims 1 to 23.

34. The method of claim 33, further comprising:
performing the reaction in the presence of a Lewis acid, preferably B(C₆F₅)₃.

35. The method of claim 33 or 34, wherein the method is a ring opening polymerization reaction (ROMP) of a norbornene, a norbornadiene or a dicylopentadiene.

36. A compound selected from: 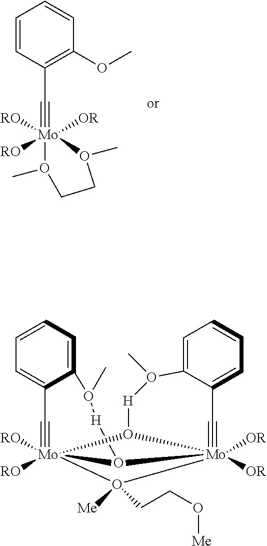
wherein RO is selected from (CF₃)(CH₃)₂CO—, (CF₃)₂(CH₃)CO— or (CF₃)₃CO—, preferably (CF₃)₂(CH₃)CO—.

37. A method of making a compound as defined in claim 19 or 20, comprising step (E):
(E) reacting a compound as defined in any one of claims 1 to 18 or 21 to 23 with an oxidic solid support under the proviso that none of R³ or R⁴ in the compound of formula I used in step (E) is a covalent bond linking Mo to an oxidic solid support.

38. The compound of any one of claims 1 to 23, wherein the compound is of formula Ia 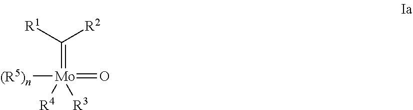
wherein:
one of R¹ and R² is H and the other is an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each of R³ and R⁴ is independently halogen, R, —N(R)₂, —NRC(O)R, —NRC(O)OR, —NRC(O)N(R)₂, —NRSO₂R, —NRSO₂N(R)₂, —NROR, —OR, or an optionally substituted group selected from a 5-6 membered monocyclic heteroaryl ring having at least one nitrogen and 0-3 additional heteroatoms independently selected from nitrogen, oxygen, or sulfur, a 4-7 membered saturated or partially unsaturated heterocyclic ring having at least one nitrogen and 0-2 additional heteroatoms independently selected from nitrogen, oxygen, or sulfur, a 7-10 membered bicyclic saturated or partially unsaturated heterocyclic ring having at least one nitrogen and 0-4 additional heteroatoms independently selected from nitrogen, oxygen, or sulfur, or an 8-10 membered bicyclic heteroaryl ring having at least one nitrogen and 0-4 additional heteroatoms independently selected from nitrogen, oxygen, or sulfur; or
two R groups on the same nitrogen atom are taken together with the nitrogen to form an optionally substituted 3-12 membered saturated, partially unsaturated, or aryl ring having 0-5 additional heteroatoms not including the same nitrogen atom independently selected from nitrogen, oxygen, or sulfur; or:
each R is independently hydrogen or an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2.

39. The compound of any one of claims 1 to 23, wherein the compound is of formula Ib 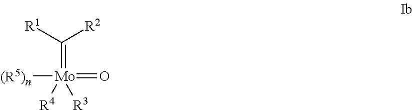
wherein:
one of R¹ and R² is H and the other is an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each of R³ and R⁴ is independently halogen, R, —N(R)₂, —NRC(O)R, —NRC(O)OR, —NRC(O)N(R)₂, —NRSO₂R, —NRSO₂N(R)₂, —NROR, —OR, or an optionally substituted group selected from a 5-6 membered monocyclic heteroaryl ring having at least one nitrogen and 0-3 additional heteroatoms independently selected from nitrogen, oxygen, or sulfur, a 4-7 membered saturated or partially unsaturated heterocyclic ring having at least one nitrogen and 0-2 additional heteroatoms independently selected from nitrogen, oxygen, or sulfur, a 7-10 membered bicyclic saturated or partially unsaturated heterocyclic ring having at least one nitrogen and 0-4 additional heteroatoms independently selected from nitrogen, oxygen, or sulfur, or an 8-10 membered bicyclic heteroaryl ring having at least one nitrogen and 0-4 additional heteroatoms independently selected from nitrogen, oxygen, or sulfur; or
two R groups on the same nitrogen atom are taken together with the nitrogen to form an optionally substituted 3-12 membered saturated, partially unsaturated, or aryl ring having 0-5 additional heteroatoms not including the same nitrogen atom independently selected from nitrogen, oxygen, or sulfur; or:
each R is independently hydrogen or an optionally substituted group selected from:
C₁₋₂₀ aliphatic, C₁₋₂₀ heteroaliphatic having 1-3 heteroatoms independently selected from nitrogen, oxygen, or sulfur; phenyl; a 3-7 membered saturated or partially unsaturated carbocyclic ring; an 8-10 membered bicyclic saturated, partially unsaturated or aryl ring; a 5-6 membered monocyclic heteroaryl ring having 1-4 heteroatoms independently selected from nitrogen, oxygen, or sulfur; a 4-7 membered saturated or partially unsaturated heterocyclic ring having 1-3 heteroatoms independently selected from nitrogen, oxygen, or sulfur; a 7-10 membered bicyclic saturated or partially unsaturated heterocyclic ring having 1-5 heteroatoms independently selected from nitrogen, oxygen, or sulfur; or an 8-10 membered bicyclic heteroaryl ring having 1-5 heteroatoms independently selected from nitrogen, oxygen, or sulfur;
each R⁵ is independently a monodentate ligand, or two R⁵ are taken together with their intervening atoms to form an optionally substituted bidentate group;
n is 0, 1, or 2; or
one of R³ or R⁴ is a covalent bond linking Mo to an oxidic solid support;
and wherein
one of R³ or R⁴ is a covalent bond linking Mo to an oxidic solid support.
